(19) United States
(12) Patent Application Publication
(10) Pub. No.: US 2009/0197790 A1
(43) Pub. Date: Aug. 6, 2009

(54) Drip resistant cleaning compositions

(75) Inventors: Tapashi Sengupta, Barrington, IL (US); Gregory G. Plutko, Glen Ellyn, IL (US); Ashoke K. SenGupta, Barrington, IL (US); Charvi Patel, Rantoul, IL (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: AMCOL International Corporation, Hoffman Estates, IL (US)

(21) Appl. No.: 12/322,699

(22) Filed: Feb. 5, 2009

Related U.S. Application Data
(60) Provisional application No. 61/075,579, filed on Jun. 25, 2008.
(60) Provisional application No. 61/026,454, filed on Feb. 5, 2008.
(60) Provisional application No. 61/111,261, filed on Nov. 4, 2008.

(51) Int. Cl. C11D 3/08; C11D 3/42; C11D 3/395

(52) U.S. Cl. 510/372; 510/405; 510/394; 510/370; 510/417; 510/435

(57) ABSTRACT

The present disclosure is directed to both sprayable and non-sprayable cleaner compositions comprising 1 to 9% by weight of a layered phyllosilicate, 1 to 10% of a surfactant, and at least one silicate salt or strong base as a pH-adjusting agent. The composition optionally can include hypochlorite bleach and the pH of the formulation can be in the range 11 to 14. The composition optionally can include water-insoluble glycol ether type solvents or oils in the form of emulsions or microemulsions for degreasing, disinfecting, and fragrance delivery. The compositions provide improved drip resistance when sprayed on to vertical surfaces.

### CROSS-REFERENCE TO RELATED APPLICATIONS

This application claims the benefit of provisional application Ser. No. 61/111,261, filed Nov. 4, 2008, Ser. No. 61/075,579, filed Jun. 25, 2008, and Ser. No. 61/026,454, filed Feb. 5, 2008.

### BACKGROUND

The high pH of many household and commercial cleaning and/or bleaching products contributes to the effectiveness of such products in cleansing and degreasing soiled surfaces and bleaching discolored or non-white surfaces. Sprayable products provide improved convenience, ease of use, and the ability to reach hard to access areas, and cleaning and/or bleaching products that foam upon contact with the surface increase the surface area of coverage. Cleaning products are frequently applied to vertical surfaces, which results in dripping and reduced contact of the product with the soiled surface. Products that resist dripping would improve both the effectiveness of the cleaner by increasing the amount/concentration and duration of contact between the cleaning product and the spill, and would improve convenience by reducing or eliminating dripping of the cleaning product. In addition, cleaning products are often formulated with volatile organic compounds (VOCs), and elimination or reduction of VOCs from cleaning compositions is desirable to reduce emissions and increase compliance with environmental regulations.

### SUMMARY

The present disclosure is directed to a sprayable, foaming cleaning composition comprising about 0.5 to about 9% by weight of a layered phyllosilicate, about 0.1 to about 10% of a surfactant, and a pH-adjusting agent selected from the group consisting of silicate salts, strong bases and mixtures thereof, said compositions having a pH of about 10 to about 14, and wherein the composition has resistance to dripping on a vertical substrate.

In one aspect, the layered phyllosilicate can be selected from the group consisting of smectite clays, montmorillonite clays, bentonite clays, hectorites, ion-exchanged montmorillonite clays, attapulgites, sepiolites, and mixtures thereof.

In another aspect, the composition can further include about 0.5 to about 10% of a bleaching compound.

In other aspects, the pH-adjusting agent can be a silicate salt in an amount from about 0.1 to about 10% by weight of the composition. In some embodiments, the silicate salt can be an alkaline earth or alkali metal salt selected from the group consisting of sodium silicate, potassium silicate, lithium silicate, magnesium silicate, calcium silicate, and mixtures thereof. The pH-adjusting agent also can be a strong base selected from the group consisting of sodium hydroxide, potassium hydroxide, lithium hydroxide, magnesium hydroxide, calcium hydroxide, and mixtures thereof.

In other aspects, the composition can further include a hydrotope in a weight ratio of at least 1:1 based on an amount of anionic surfactant in the composition, wherein the pH is about 11 to about 14.

In some embodiments, the composition can comprise about 0.5 to about 3% by weight of a montmorillonite clay; about 1 to about 5% by weight of an amine oxide surfactant; about 0.5 to about 5% by weight of a silicate salt; about 5 to about 20% by weight of a hydrotope; and about 5 to about 25% of one or more ethers. In other embodiments, the composition can comprise about 0.5 to about 3% by weight of a montmorillonite clay; about 1 to about 5% by weight of an amine oxide surfactant; about 0.25 to about 5% by weight sodium hydroxide; about 0.25 to about 5% by weight water; about 5 to about 20% by weight of a hydrotope; and about 5 to about 25% by weight of one or more ethers. In still other embodiments, the composition can comprise about 0.5 to about 3% by weight of a montmorillonite clay; about 1 to about 5% by weight of an amine oxide surfactant; about 0.5 to about 5% by weight of a silicate salt; about 0.5 to about 10% by weight of a 50% solution of sodium hydroxide in water; about 5 to about 20% by weight of a hydrotope; and about 5 to about 25% by weight of one or more ethers.

In some aspects, the composition can further include mixed metal oxides/hydroxides to increase a viscosity of the composition and provide shear thinning of the composition in pre-gel form.

In other aspects, the phyllosilicate pre-gels contain an extending polymer, such as a polyacrylate in the molecular weight range of 1-15 million Daltons, preferably in the range 1-10 million Daltons, with 100% to 70% anionic character, to provide a further increase in viscosity. In some aspects, the phyllosilicate pre-gels can contain non-extending polymers selected from the group consisting of xanthan gum, cellulosics, guar gum, locust bean gum and combinations thereof to provide an increase in viscosity. The phyllosilicate pre-gels also can contain optical brighteners such as TiO₂ in an amount of 0.5-15% (w/w) based on the weight of clay and said brightener having a particle size of 0.2-0.3 micron to provide a white formulation and a whiter foam. The pre-gel formulations can be sufficiently viscous and have a sufficiently high pH for suspension of negatively charged pigments, optical brighteners, and other aesthetic pigments such as colored pigments, or dye-clay complexes, or food coloring, or pearlescent mica. The pre-gel formulations can be prepared with phyllosilicate particles having a size of about 1 micron to about 2 microns such that the pre-gel compositions are beige to brownish or greenish colored and yet provide white to off-white foams due to the size of the phyllosilicate particles generated during the efficient dispersion of the phyllosilicate in the pre-gel state.

In some aspects, the high shear viscosity of the phyllosilicate pre-gel compositions can be in the range 100-800 cP, more preferably in the range 140-500 cP, and most preferably in the range 150-350 cP, measured at 0.5 rpm with spindle 3 or 4 in a Brookfield Rheometer. In some aspects, the low shear viscosity of the formulation with the phyllosilicate pre-gel compositions can be in the range of 3500-100,000 cP, more preferably in the range 10,000-60,000 cP, and most preferably in the range 15,000-45,000 cP, measured at 0.5 rpm with spindle 3 or 4 in a Brookfield Rheometer. In some aspects, the degree of shear thinning of the formulations as defined by the ratio of viscosity at 0.5 rpm to the viscosity at 200 rpm can be in the range of 10-400, more preferably in the range of 40-350, most preferably in the range of 140-350. In some aspects, the phyllosiliate pre-gels can be highly thixotropic and highly shear thinning at high shear, but regain sufficient viscosity at low shear such that the foam from the composition is non-dripping on a vertical surface.

In some aspects, all particles are above 100 nm in particle size and, therefore, are not nano particles.

In some aspects, the composition can comprise less than about 2% by weight of volatile organic compounds. In other aspects, the composition can comprises less than about 0.5% by weight of volatile organic compounds.

In some aspects, the phyllosilicates can have a cation exchange capacity (CEC), in the range of 25-150, and are in a form selected from 100% sodium exchangeable cations, and mixed exchangeable cations selected from the group consisting of sodium, calcium, and magnesium.

In some aspects, the pH-adjusting agent can be a combination of a silicate salt and a strong base, and wherein the composition has a pH of about 10 to about 11.5. In some aspects, the pH-adjusting agent can be a strong base, and wherein the composition has a pH of about 11 to about 13.5. In some aspects, the composition can have sufficient strong base to raise the pH of the composition in the range of 12.5 to 13.5.

In some aspects, the hydrotype can be selected from the group consisting of sodium xylene sulfonates, sodium cumene sulfonates, sodium toluene sulfonates, ethanol, isopropanol, propylene glycol, polyethylene glycol ethers, alkyl polyglucosides.

In some aspects, the bleaching agent can be selected from the group consisting of sodium hypochlorite (NaOCl); hydrogen peroxide; sodium perbonate; sodium percarbonate; tetra acetyl ethylene diamine; and mixtures thereof.

The present disclosure also is directed to a method of providing sprayability and foam in a composition having a pH in the range of 10 to 14 that contains about 0.5 to about 6% by weight of a layered silicate and an anionic surfactant, comprising adding a hydrotope to said composition in an amount of at least a weight ratio of 1:1 based on the weight of anionic surfactants in the composition. In some aspects, the hydrotype can be selected from the group consisting of sodium xylene sulfonates, sodium cumene sulfonates, sodium toluene sulfonates, ethanol, isopropanol, propylene glycol, polyethylene glycol ethers, alkyl polyglucosides.

The present disclosure is further directed to a sprayable, foaming cleaning composition comprising about 0.5 to about 9% by weight of a layered phyllosilicate, about 0.1 to about 10% of a surfactant, and a pH-adjusting agent, wherein the composition is in the form of a oil-in-water macro-emulsion or an oil/water microemulsion having an oil phase and an aqueous phase. In some aspects, the oil phase can comprise a water-insoluble oil or solvent selected from the group consisting of degreasing oils or solvents, disinfecting oils or solvents, and fragrance-releasing oils or solvents.

### BRIEF DESCRIPTION OF THE DRAWINGS

FIGS. 1A-1B are color photographs showing Dawn Power Dissolver commercial formula control.

FIGS. 2A-2B are color photographs showing Formulation 12B using AMCOL (A+C) rheology modifier and NaOH.

FIGS. 3A-3C are color photographs showing Formulation 13B using AMCOL (B+C) rheology modifier with NaOH and Formulation 13A using AMCOL (B+C) with silicate.

FIGS. 4A-4C are color photographs showing Formulation 8B and 8 with AMCOL B rheology modifier and silicate, Formulation 8C with AMCOL B rheology modifier and NaOH.

FIGS. 5A-5B are color photographs showing Formulation 12A with AMCOL (A+C) rheology modifier and silicate.

FIGS. 6A-6B are color photographs showing Formulation 6 with AMCOL A rheology modifier and silicate.

FIG. 7 is a color photograph showing formulations made with AMCOL A and AMCOL B pre-gels.

FIGS. 8A-8F are color photographs of foams taken right after dispensing for the 17 series formulations.

FIGS. 9A-9E are color photographs of foams taken right after dispensing for the 19 series formulations.

FIGS. 10A-10F are color photographs of foams taken right after dispensing for the 22 and 23 series formulations.

FIGS. 11A-11C are color photographs of foams taken right after dispensing for the 25 series formulations.

FIG. 12a is a graph showing viscosity profiles of AMCOL A aluminosilicate-based formulations.

FIG. 12b is a graph showing viscosity profiles of AMCOL A aluminosilicate based formulations in log-log.

FIG. 13a is a graph showing rheology profiles of AMCOL B aluminosilicate based clay based formulations.

FIG. 13b is a graph showing rheology profiles of AMCOL B aluminosilicate based formulations in log-log.

FIG. 14a is a graph showing viscosity profiles for AMCOL aluminosilicate and Laponite pre-gels in deionized water.

FIG. 14b is a graph showing viscosity profiles for AMCOL aluminosilicate with additives and Laponite pre-gels in deionized water.

FIG. 15a is a graph showing viscosity profiles for additional AMCOL aluminosilicate and Laponite pre-gels in deionized water in semi-log plot.

FIG. 15b is a graph showing viscosity profiles for additional AMCOL aluminosilicate and Laponite pre-gels in deionized water in log-log plot.

FIG. 16a is a graph showing viscosity profiles for AMCOL aluminosilicate pre-gels with additives in deionized water in semi-log plot.

FIG. 16b is a graph showing viscosity profiles for AMCOL aluminosilicate pre-gels with additives in deionized water in log-log plot.

FIG. 17a is a graph showing viscosity profiles for formulations prepared with the second set of pre-gels (single and mixtures) without any additives.

FIG. 17b is a graph showing viscosity profiles for formulations prepared with the second set of pre-gels (single and mixtures) without any additives.

FIG. 17c is a graph showing viscosity profiles for formulations prepared with the second set of pre-gels (single and mixtures) without any additives.

FIG. 18a is a color photograph showing formulations after being centrifuged at 2000 rpm for 15 min compared to Dawn Oven cleaner commercial formula on the left.

FIG. 18b is a color photograph showing formulations after being centrifuged at 2000 rpm for 15 min.

FIG. 19 is a graph showing viscosity of bleach formulations at pH 13 with 1.5-2% (w/w) aluminosilicate solids, 5-6.2% (w/w) hydrotope, 0-5% anionic surfactants, 2.6% sodium hypochlorite.

FIG. 20 is a graph showing viscosity of bleach formulations at pH 13 with 2% (w/w) aluminosilicate solids, 0-2.5% (w/w) hydrotope, 0-5% anionic surfactants, 2.6-3% sodium hypochlorite.

FIG. 21 is a graph showing viscosity of bleach formulations at pH 13 with 1.6-2% (w/w) aluminosilicate solids, 5.4% (w/w) hydrotope, 0-5% anionic surfactants, 2.6-6% sodium hypochlorite.

FIGS. 22A-22O are color photograph showing thickened bleach formulation non-dripping foams, when sprayed on to a vertical substrate.

FIG. 23 is a graph showing viscosity of AMCOL clays and synthetic clay at low shear and over a wide range of solution pH.

FIG. 24 is a graph showing degree of shear thinning of AMCOL clays and synthetic clay over a wide range of solution pH.

FIG. 25 is a graph showing effect of salt and ionic strength on AMCOL clays and synthetic clay.

FIG. 26 is a graph showing degree of shear thinning of AMCOL clays and synthetic clay over a wide range of salt concentration

### DETAILED DESCRIPTION

The present disclosure is directed to sprayable, high pH, e.g., 10-14, compositions useful for cleaning and/or bleaching surfaces, such as vertical surfaces, and having improved resistance to dripping. Examples of surfaces that are cleaned using the present compositions include, but are not limited to, cooking surfaces and cookware, and particularly include cooking surfaces that are soiled with burnt on and/or baked on food and/or grease. Specific examples of such surfaces include, but are not limited to, ovens, grills, pots, pans, and stovetops, greasy kitchenware, utensils, countertops, vertical/horizontal glass surfaces, tiles, or other greasy parts/machinery used in manufacturing factory areas. The same products can be used on horizontal surfaces as well.

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Conventional cleaner compositions include inorganic particulates such as laponite (a synthetic hectorite) in combination with polymeric thickening agents. The small size of laponite particles (about 1 to about 30 nm) has raised safety concerns regarding inhalation of fine nano particles provided in cleaning sprays. An alternative to laponite having larger particle sizes would be desirable to alleviate concerns related to particle size. In the present disclosure, clays having particles sizes in the range of about 0.05 μm to about 10 μm, preferably about 0.1 μm to about 5 μm, more preferably about 0.2 to about 2 μm are added to cleaning compositions to provide thickening properties.

The cleaning compositions described herein may or may not include a bleaching compound, such as NaOCl and may or may not contain a hydrotope such as those selected from sodium xylene sulfonates, sodium cumene sulfonates, sodium toluene sulfonates, ethanol, isopropanol, propylene glycol, polyethylene glycol ethers, and/or an alkyl polygluosides. Preferred clays include clays having a sheet-like or platey-structure, including layered phyllosilicates, such as smectite clay minerals, e.g., montmorillonite, particularly sodium montmorillonite; lithium montmorrillonite; magnesium montmorillonite and/or calcium montmorillonite; hectorite; bentonite; nontronite; beidellite; volkonskoite; saponite; sauconite; sobockite; stevensite; svinfordite; vermiculite; magadite; kenyaite and the like. Other useful layered materials include micaceous minerals, such as mica, illite, and mixed layered illite/smectite minerals, such as rectorite, tarosovite, ledikite and admixtures of illites with the clay minerals named above. The clays comprise refined but unmodified clays, modified clays or mixtures of modified and unmodified clays. Modified clays include intercalated layered clay materials prepared by the cation exchange reaction of a water-swellable layered clay particle with an inorganic cation, such as a sodium, potassium, lithium, or ammonium compound, preferably a sodium compound, preferably an onium ion-liberating compound, to affect partial or complete cation exchange.

Intercalates are sold commercially as Nanomer® nanoclays (Nanocor, Inc.). Examples of suitable layered phyllosilicate clays include, but are not limited to, polymer grade (PG) montmorillonites such as PGN, PGW, and PGV clays (Nanocor, Inc.), PGL IX clay. Such polymer grade clays are purified in accordance with U.S. Pat. Nos. 6,050,509 and 6,596,803, hereby incorporated by reference in their entirety. Other clays such as Polargel NF, Attapulgites (Active Minerals sourced attapulgites, Engelhard attapulgites or from other sources), AMCOL montmorrilonite clays such as Grey Prassa, White Prassa, Peker, Lalapassa, CGS, DRB (exchanged or activated in the sodium form from their usual calcium/magnesium variety) can be used for more aesthetic, whiter rheology modifiers in home and personal care industries. Moreover, the clay minerals may have a wide range of CEC (cation exchange capacity) from 25 to 160 meq/100 gm clay and may be partially in sodium/calcium/magnesium forms to provide the optimum rheology in different solvent mixtures. Mixtures of clays may be used and clays may be combined with one or more additives such as MMH mineral oxide/hydroxide for further development of viscosity. Also, clay pre-gels used in such applications may be dosed with an optical whitener such as pigment grade titanium dioxide (0.2-0.3 microns), in the range 0.5-15% (w/w) based on clay, to provide a white colored formulation and whiter foam when dispensed on a substrate. Mineral pigments with iso-electric points lower than the formulation pH will have a negative charge and may be dispersed in the negatively charged aluminosilicates gel network via electrostatic stabilization very effectively. It is also sometimes desired that the dried residue on any substrate be white in color to generate the right consumer perception/cue associated with any cleaner formulation. Optical whiteners can help in providing such white residues when mixed with bentonites. Similarly, colored pigments or pearlescent pigments such as mica can be suspended very effectively in these formulations to obtain the desired aesthetics as these formulations have a very high viscosity at low shear. Colored clays may be also used for aesthetics by using clay-dye complexes such as methylene blue or crystal violet or dyes with appropriate functional groups for adsorption on clay surfaces. These colored clays can act as pigments too.

Cleaning compositions prepared with particulate laponite are known to drip when applied by spraying onto a vertical or otherwise non-horizontal surface. In contrast, cleaner compositions of the present disclosure are drip resistant. As used herein, the term “drip resistant” means the cleaner composition does not drip immediately down a vertical surface when sprayed onto the vertical surface, and preferably does not drip for at least about 5 seconds, more preferably at least about 30 seconds, even more preferably at least about 1 minute, most preferably at least about 1 hour or more, after being sprayed onto the vertical surface.

Conventional cleaner formulations are provided at high pH (greater than about pH 12) and further include corrosion inhibiting compounds such as sodium silicate. Strong bases such as sodium hydroxide are typically used to achieve high pH values, but silicate also contributes to elevated pH. The present disclosure is directed to cleaner compositions, with or without a bleaching compound, such as NaOCl, comprising a layered phyllosilicate clay and a silicate salt, having resistance to dripping when sprayed on a non-horizontal, e.g., vertical surface. The use of layered phyllosilicate clays, instead of particulate laponite, was found to dramatically improve the drip resistance of formulations comprising such clays. Suitable silicate salts include alkaline earth and alkali metal salts such as sodium silicate, potassium silicate, lithium silicate, magnesium silicate, and/or calcium silicate. Preferred cleaner compositions comprise about 0.5 to about 6% by weight of a layered phyllosilicate clay and about 0.1 to about 10% by weight of a silicate salt. In a specific example, the cleaner composition comprises about 1 to about 4% by weight of the layered phyllosilicate clay and about 1.8 to about 2.5% by weight of sodium silicate, having a pH below about 11.5. In another specific example, the cleaner composition comprises about 1 to about 2% by weight of the layered phyllosilicate clay and about 1.8 to about 2.5% by weight of sodium silicate, having a pH below about 11.5. Some of the conventional cleaners also contain anionic (polyacrylate type), hydrophobically modified anionic (HASE type), or slightly anionic/nonionic polymers (Xanthan gum) as thickening agents. However, polymers are not that effective thickeners under high salt conditions compared to the AMCOL aluminosilicates at the same active level. Also, polymer containing formulations do not exhibit the same level of shear thinning and thixotropy as the AMCOL aluminosilicate containing formulations. Moreover, polymers are usually more expensive than bentonites or even the purified AMCOL aluminosilicates.

The present disclosure is also directed to cleaner compositions, with or without a bleaching compound, comprising a layered phyllosilicate clay and a strong base, having resistance to dripping when sprayed on a non-horizontal surface. The use of layered phyllosilicate clays, instead of particulate laponite, was found to dramatically improve the drip resistance of formulations comprising such clays. Suitable strong bases include alkaline earth and alkali metal bases such as sodium hydroxide, potassium hydroxide, lithium hydroxide, magnesium hydroxide, and/or calcium hydroxide. Preferred cleaner compositions comprise about 0.5 to about 9% by weight of a layered phyllosilicate clay and sufficient strong base to adjust the pH of the formulation to a pH of about 10 to about 14. In a specific example, the cleaner compositions comprise about 0.5 to about 6% by weight of a layered phyllosilicate clay and sufficient strong base to adjust the pH of the formulation to a pH of about 10 to about 14. In another specific example, the cleaner composition comprises about 1 to about 4% by weight of the layered phyllosilicate clay and sufficient sodium hydroxide to adjust the pH of the formulation to a pH of about 12 to about 13.5. In still another specific example, the cleaner composition comprises about 1 to about 2% by weight of the layered phyllosilicate clay and sufficient sodium hydroxide to adjust the pH of the formulation to a pH of about 12 to about 13.5.

The present disclosure is further directed to cleaning compositions, with or without a bleaching compound, comprising a layered phyllosilicate clay, a silicate salt, and a strong base, having resistance to dripping when sprayed on a non-horizontal surface. The use of layered phyllosilicate clays, instead of particulate laponite, was found to dramatically improve the drip resistance of formulations comprising such clays. Preferred silicate salts include sodium silicate, potassium silicate, lithium silicate, magnesium silicate, and/or calcium silicate. Suitable strong bases include alkaline earth and alkali metal bases such as sodium hydroxide, potassium hydroxide, lithium hydroxide, magnesium hydroxide, and/or calcium hydroxide. Preferred cleaner compositions comprise about 0.5 to about 9% by weight of a layered phyllosilicate clay, about 0.1 to about 10% by weight of a silicate salt, and sufficient sodium hydroxide to adjust the pH of the formulation to a pH of about 10 to about 14. In a specific example, cleaner compositions comprise about 0.5 to about 6% by weight of a layered phyllosilicate clay, about 0.1 to about 10% by weight of a silicate salt, and sufficient sodium hydroxide to adjust the pH of the formulation to a pH of about 10 to about 14. In another specific example, the cleaner composition comprises about 1 to about 4% by weight of the layered phyllosilicate clay, about 1.8 to about 2.5% by weight of sodium silicate, and sodium hydroxide, and has a pH above about 10.7, preferably above about 11.0, more preferably above about 11.5. In yet another specific example, the cleaner composition comprises about 1 to about 2% by weight of the layered phyllosilicate clay, about 1.8 to about 2.5% by weight of sodium silicate, and sodium hydroxide, and has a pH above about 10.7, preferably above about 11.0, more preferably above about 11.5.

Formulations prepared with about 1.8 to about 2.5% by weight of sodium silicate and low amounts (about 1 to about 2% by weight) of PGN or PGW clays were found to abruptly decrease in viscosity when sufficient sodium hydroxide was added to adjust the pH to a pH above about 11.5, for example, 11.5 to 12.3, and/or 11.5 to 12.0. Such formulations are less suitable as cleaners due to the resulting decrease in drip resistance. However, when the viscosity of these formulations increase as pH of the formulations is raised to about 12.9-13.5 with a bleaching compound or excess NaOH, these formulations again become suitable for drip resistant spray cleaners.

Without subscribing to one particular mechanism, the loss in viscosity may be explained by the pH-dependent equilibria between silicic acid, colloidal/polymeric silica, and silicate anion. In the presence of silicate and sodium hydroxide, above about pH 11.5, the equilibrium is shifted toward silicate anions. The negatively charged silicate anions are highly effective in dispersing aluminosilicate clays by surface complexation with trivalent or divalent cations at the edge of the platelets and physical adsorption on to the face of clay particles leading to an increased overall net surface charge. This disrupts the positive-edge/negative-face interactions by which viscosity is developed in montmorrilonite dispersions, and leads to a low viscosity formulation. This effect was found to be more noticeable for the highly flocculating, higher viscosity PGN- and PGW-based formulations (including PGN and PGW formulations with additive) compared to the lower viscosity laponite formulations at the same weight percentage at pH 11.9-12.3. However, with addition of NaOH and thereby increase in pH of the formulation, ionic strength of the formulation also increases leading to re-flocculation of the dispersed clay particles and increased viscosity. This probably occurs due to the compression of the double layer thickness around the highly negatively charged particles with increase in ionic strength, leading to decreased repulsive interactions and probable trapping of particles in a network of secondary energy minima forming a viscous structure.

In the present disclosure, optional modifiers, including polymeric modifiers, are added to obtain formulations comprising silicate, and having a pH above about 11.5 with resistance to dripping. Optional modifiers, including polymeric modifiers, are also added to obtain formulations comprising silicate, sodium hydroxide, and having a pH above about 12.9-13.5 with resistance to dripping. Examples of suitable polymeric modifiers include, but are not limiting to, high salt tolerant polymers, such as xanthan gum, modified CARBOPOL®, xanthan/locust bean gums, guar/xanthan, nonionic cellulosic polymers, and cationic guar/xanthan. Extending polymers, such as high molecular weight polyacrylates Hychem AF 251 or others (Alcomer 1771, Magnfloc 611) in the molecular weight range 1 Million to 15 Million Daltons, with 100% to 70% anionic character, may be used to develop the viscosity of such formulations at lower clay content due to more efficient flocculation induced by the extending polymers. Resistance to dripping at high pH (greater than about 11.5) is also obtained by preparing formulations comprising silicate and high amounts of aluminosilicate clays (1.5-9%).

The formulation of the present disclosure optionally comprises various additives. These additives include surfactants, such as sodium lauryl sulfate (SLS, Stepanol WA Extra), sodium laureth sulfate (SLES, STEOL CS 270), amine oxide surfactants (e.g. lauramine oxide); hydrotopes, such as sodium xylene sulfonates, sodium cumene sulfonates, sodium toluene sulfonates, ethanol, isopropanol, propylene glycol, polyethylene glycol ethers, and/or an alkyl polygluosides; corrosion inhibitors; pH-adjusting agents; non-VOC organic solvents such as Dow P-series glycol ether solvents and E-series glycol ether solvents. The glycol ether solvents used in cleaner formulations as effective degreasers may be ethylene glycol phenyl ether (Eph), dipropylene glycol butyl ether (DPnB), propylene glycol butyl ether (PnB), tripropylene glycol butyl ether (TPnB), dipropylene glycol propyl ether (DPnP), propylene glycol phenyl ether (PPh); and organic bases, such as triethanol amine or monoethanol amine.

The preferred formulations of the present disclosure are also substantially free (less than 2%, more preferably less than 0.5%) from volatile organic compounds. Volatile organic compounds are defined by the U.S. Environmental Protection Agency in the Code of Federal Regulations as any compound of carbon, excluding carbon monoxide, carbon dioxide, carbonic acid, metallic carbides or carbonates, and ammonium carbonate, which participates in atmospheric photochemical reactions. The formulations of the present disclosure comprise less than about 8% by weight of volatile organic compounds, preferably less than about 5% by weight of volatile organic compounds, more preferably less than about 2% by weight of volatile organic compounds, most preferably less than about 0.5% by weight of volatile organic compounds.

The formulation in the present disclosure may be also an oil-in-water macro emulsion or an oil/water microemulsion where the oil phase constitutes a water-insoluble oil/solvent for multiple functionalities, for example, a degreasing oil/solvent, a disinfecting solvent like terpeneol, or a fragrance releasing solvent. Such formulations may also contain the AMCOL aluminosilicates as thickening agents.

### Equilibria of Silicate Solutions

A sodium silicate solution consists of monomeric and polymeric species and the concentration of each depends on the silica content and the SiO₂/Na₂O ratio of the solution as shown in equations (1)-(3). Equation (1) describes colloidal polymeric silica in equilibrium with silicic acid.

SiₙO_{(4n-nx)/2}(OH)ₙₓ+[4n−nx/2]H₂O [symbol] nSi(OH)₄ (1)

Equation (2) depicts silicic acid in equilibrium with silicate ions.

Si(OH)₄+2OH⁻ [symbol] (HO)₂SiO₂²⁻+2H₂O (2)

Equation (3) shows silicate anions in equilibrium with colloidal or polymerized silica.

nSiO₃⁻²+3nH2O [symbol] (H₂SiO₃)ₙnH₂O+2nOH⁻ (3)

When highly flocculating and viscosity building AMCOL aluminosilicates (see examples) are present as rheology modifiers in the compositions, silicate salts with very little NaOH, e.g., less than 0.4 wt. % of the composition, (as this is how silicate is supplied) can be used to increase composition viscosity, where the amount of NaOH raises the pH of the composition to 11.5 or below. NaOH alone can be used to increase viscosity where the amount of NaOH is about 0.522 wt. % to about 2 wt. % of the composition, where the amount of NaOH raises the pH of the composition to 11-13.5. Silicates and large amounts of NaOH (1 wt. %, or as needed) can be used to increase viscosity only where the amount of NaOH raises the pH of the composition to 12.5-13.5 to build higher viscosity. Silicic acid (H₄SiO₄) has pKa values of 9.9, 11.8, 12, and 12. At a pH below about 10.7, the silicate anions convert to silicic acid (Equation 2), which then polymerizes to silica (Equation 1). As pH increases above about 10.7, the predominant form of silicate is the silicate anion. The negatively charged silicate anions are highly effective in dispersing aluminosilicates by surface complexation with trivalent or divalent cations at the edge of the platelets. This disrupts the positive-edge/negative-face interactions by which viscosity is developed in aluminosilicate dispersions, and leads to a low viscosity formulation. This effect was found to be more noticeable for the higher viscosity AMCOL PGN- and PGW-based formulations (including PGN and PGW formulations with additive) compared to the lower viscosity laponite formulations at the same weight percentage. In addition, the 1% laponite formulation with NaOH and silicate (Formula 10D) was visually thinner than that with silicate alone (Formula 10A). The 2% laponite formulation with NaOH alone (Formula 10C) was also visually thinner than that with silicate alone (Formula 10B).

### Preparation of Cleaning Formulations

Formulations for rheology and spray testing were prepared according to the following general procedure. “Phase A” ingredients (AMMONYX® DMCD-40 (CAS Number: 1643-20-5) or AMMONYX®LO (CAS Number 1643-20-5), triethanol amine, and sodium xylene sulfonate) were combined in a beaker according to the weight percentages provided in Table 1, and the batch was mixed with a magnetic stirrer. Deionized water (“Phase B”) was added to the aluminosilicate pre-gel (“Phase B”) in a separate beaker. These Phase B ingredients were thoroughly mixed with a Silverson L4 RT rotor-stator mixer using a square mesh screen and mixing at low rpm (300-500 rpm) to avoid air entrapment. The “Phase A” ingredients were then added to the “Phase B”, with continued mixing. “Phase C” ingredients DOWANOL® DPnB (dipropylene glycol n-butyl ether) and DOWANOL® Eph (ethylene glycol phenyl ether) were added sequentially in the amounts provided in Table I while mixing. Mixing was continued until a uniform suspension was obtained, and pH was measured. Either silicate solution or NaOH solution (“Phase D”) alone was added in some formulations to obtain either low or high pH. This provided more flexibility in obtaining formulations with a wider range of pH. Formulations comprising silicate were prepared by gradually adding the silicate solution with continuous mixing while monitoring the formulation pH. Silicate addition was halted once the formulation reached a pH 11.5. Formulations prepared with NaOH were obtained by adding 2% of a 50% NaOH solution (Table 1), and the pH after NaOH addition was measured. Formulations prepared with both silicate and NaOH were obtained by first adding silicate to the formulation, mixing it properly and then adding the NaOH solution with proper mixing. The pH at every step was measured, with the pH of the final step being in the range 12.8-13.5. The formulations were equilibrated at 25° C. for 30 minutes prior to conducting viscosity measurements at varying shear rates with a Brookfield programmable rheometer.

TABLE 1

| Phase | Ingredient | Weight % |
|---|---|---|
| A | AMMONYX ® DMCD-40 (lauramine oxide), | 1-3 |
| | 40% active in water | |
| A | TEA, Triethanol amine | 4-7 |
| A | Sodium xylene sulfonate, 40% active in water | 10-15 |
| B | Deionized Water | To 100% |
| B | Aluminosilicate Pre-gel | Solid basis: 1-6% |
| C | DOWANOL ® DPnB (dipropylene glycol | 3-7 |
| | n-butyl ether) | |
| C | DOWANOL ® Eph (ethylene glycol phenyl) | 3-7 |
| | ether | |
| D | Sodium silicate, ~40% active in water | 2.5 |
| D | 50% Sodium Hydroxide (50% water) | 2%, To pH 12-13, |

The first set of exemplary formulations is without a bleaching compound (NaOCl), and is summarized in Table 2. Formulations were prepared with 1 to 2% by weight of various aluminosilicate pre-gels, including PGN clay (“AMCOL A”), PGW clay (“AMCOL B”), PGN clay with MMH (mixed metal hydroxide) mineral oxide/hydroxide additive (“AMCOL (A+C)”), PGW clay with MMH mineral oxide/hydroxide additive (“AMCOL (B+C)”), and laponite. Mixed metal hydroxides or layered double hydroxides are layered Poly (magnesium-aluminum-oxide-hydroxide) particles (diameter ˜0.1 microns), commercially known as MMH and sold as Polyvis II by SKW/Degussa/BASF. These particles are positively charged and thereby can form network structure with negatively charged clay particles. PGN clay and PGW clay are both highly processed and purified by ion-exchange in sodium form. AMCOL (A+C) and AMCOL (B+C) aluminosilicate pre-gels were prepared with 4% clay and 0.58% additive. The formulations were made with 1.82 to 2.5% by weight sodium silicate and/or 2% by weight of a 50% solution of sodium hydroxide.

TABLE 2
High pH degreasing cleaner formulations prepared
with AMCOL A and AMCOL B

| | | | % | % | |
|---|---|---|---|---|---|
| | | | Silicate | NaOH | |
| | | % of | (~40% | (50% | |
| | Aluminosilicate | aluminosilicate, | active), | soln.), | |
| Formula # | type | (wt/wt) | (wt/wt) | (wt/wt) | pH |
| 6 | AMCOL A | 2 | 2.5 | | 11.42 |
| 7 | AMCOL A | 2 | | 2 | 12.91 |
| 8B | AMCOL B | 2 | 2.5 | | 11.39 |
| 8C | AMCOL B | 2 | | 2 | 12.69 |
| 12A | AMCOL | 2 | 1.82 | | 11.45 |
| | (A + C) | | | | |
| 12B | AMCOL | 2 | | 2 | 12.93 |
| | (A + C) | | | | |
| 13A | AMCOL | 2 | 2.5 | | 11.49 |
| | (B + C) | | | | |
| 13B | AMCOL | 2 | | 2 | 12.76 |
| | (B + C) | | | | |
| 10A | laponite | 1 | 2.5 | | 11.43 |
| 10B | laponite | 2 | 2.5 | | 11.45 |
| 10C | laponite | 2 | | 2 | 12.63 |
| 10D | laponite | 1 | 2.5 | 2 | 12.91 |
| Dawn Power | laponite | 2 | 2.5 | 2 | 13.33 |
| Dissolver | | | | | |
| Commercial | | | | | |
| formula | | | | | |
| control | | | | | |

Detailed formulation descriptions are provided below.

Formula #7 - 2% Amcol A

| | | | Total amount, | pH | Conductivity, |
|---|---|---|---|---|---|
| Phase | Ingredient | Weight, % | gm | @20° C. | mS |
| A | Deionized water | To 100% | 173 | 12.91 | 33.8 mS |
| A | Clay pre-gel | 2 | 167 | | |
| | (6% AMCOL A pre-gel) | | | | |
| B | AMMONYX ® DMCD-40 | 2.5 | 12.5 | | |
| | (40% active, 23% ethanol) | | | | |
| | Chemical name: lauramine | | | | |
| | oxide | | | | |
| B | Sodium xylene sulfonate | 12.5 | 62.5 | | |
| | (40% active) | | | | |
| B | TEA | 5 | 25 | | |
| C | Dowanol DPnB | 5 | 25 | | |
| C | Dowanol EpH | 5 | 25 | | |
| D | Sodium silicate, ~40% active | 0 | 0 | | |

| | | | | |
|---|---|---|---|---|
| E | 50% Sodium hydroxide | 2 | 10 | pH = 12.91 after NaOH |
| | | | | addition |
| Total | | 100 | 500 | |

Formula #12B - 2% Amcol (A + C)

| | | | Total | pH | Conductivity, |
|---|---|---|---|---|---|
| Phase | Ingredient | Weight, % | amount, gm | @20° C. | mS |
| A | Deionized water | To 100% | 119.16 | | 11.77 mS |
| A | Clay pre-gel | 2 | 218.34 | | |
| | (4.58% AMCOL (A + C) pre-gel) | | | | |
| B | AMMONYX ® DMCD-40 | 2.5 | 12.5 | | |
| | (40% active, 23% ethanol) | | | | |
| | Chemical name: lauramine oxide | | | | |
| B | Sodium xylene sulfonate | 12.5 | 62.5 | | |
| | (40% active) | | | | |
| B | TEA | 5 | 25 | | |
| C | DOWANOL DPnB | 5 | 25 | | |

| | | | | |
|---|---|---|---|---|
| C | DOWANOL EpH | 5 | 25 | pH = 11.06 before NaOH |
| | | | | addition |
| D | Sodium silicate, ~40% active | 0 | 0 | pH = 12.93 after NaOH |
| | | | | addition |
| E | 50% Sodium hydroxide | 2 | 10 | |
| Total | | 100 | 487.5 | |

Formula #6 - 2% Amcol A

| | | | Total amount, | pH | Conductivity, |
|---|---|---|---|---|---|
| Phase | Ingredient | Weight, % | gm | @20° C. | mS |
| A | Deionized water | To | 170.5 | 11.45 | 11.81 mS |
| | | 100% | | | |
| A | Clay pre-gel | 2 | 167 | | |
| | (6% AMCOL A pre-gel) | | | | |
| B | AMMONYX ® DMCD-40 | 2.5 | 12.5 | did not separate as of | |
| | (40% active, 23% ethanol) | | | Jan. 22, 2008 | |
| | Chemical name: lauramine oxide | | | | |
| B | Sodium xylene sulfonate | 12.5 | 62.5 | quite | |
| | (40% active) | | | thick | |
| B | TEA | 5 | 25 | | |
| C | DOWANOL DPnB | 5 | 25 | | |
| C | DOWANOL EpH | 5 | 25 | | |

| | | | | |
|---|---|---|---|---|
| D | Sodium silicate, ~40% active | 2.5 | 12.5 | pH = 11.42 before NaOH |
| | | | | addition |
| E | 50% Sodium hydroxide | 0 | 0 | |
| Total | | 100 | 500 | |

Formula #12A - 2% Amcol (A + C)

| | | | Total | pH | Conductivity, |
|---|---|---|---|---|---|
| Phase | Ingredient | Weight, % | amount, gm | @20° C. | mS |
| A | Deionized water | To 100% | 119.16 | | 5.78 mS |
| A | Clay pre-gel | 2 | 218.34 | | |
| | (4.58% AMCOL (A + C) pre-gel) | | | | |
| B | AMMONYX ® DMCD-40 | 2.5 | 12.5 | | |
| | (40% active, 23% ethanol) | | | | |
| | Chemical name: lauramine oxide | | | | |
| B | Sodium xylene sulfonate | 12.5 | 62.5 | | |
| | (40% active) | | | | |
| B | TEA | 5 | 25 | | |
| C | DOWANOL DPnB | 5 | 25 | | |

| | | | | |
|---|---|---|---|---|
| C | DOWANOL EpH | 5 | 25 | pH = 11.03 before NaSilicate |
| | | | | addition |
| D | Sodium silicate, ~40% active | 1.82 | 9.08 | pH = 11.45 after NaSilicate |
| | | | | addition |
| E | 50% Sodium hydroxide | 0 | 0 | |
| Total | | 100 | 496.58 | |

Formula #8B - 2% Amcol B

| | | | Total | pH | Conductivity, |
|---|---|---|---|---|---|
| Phase | Ingredient | Weight, % | amount, gm | @20° C. | mS |
| A | Deionized water | To 100% | 170.5 | | 5.63 mS |
| A | Clay pre-gel | 2 | 167 | | |
| | (6% AMCOL B pre-gel) | | | | |
| B | AMMONYX ® DMCD-40 | 2.5 | 12.5 | | |
| | (40% active, 23% ethanol) | | | | |
| | Chemical name: lauramine oxide | | | | |
| B | Sodium xylene sulfonate | 12.5 | 62.5 | | |
| | (40% active) | | | | |
| B | TEA | 5 | 25 | | |
| C | DOWANOL DPnB | 5 | 25 | | |

| | | | | |
|---|---|---|---|---|
| C | DOWANOL EpH | 5 | 25 | pH = 10.27 before silicate |
| D | Sodium silicate, ~40% active | 2.5 | 12.5 | pH = 11.39 after silicate |
| E | 50% Sodium hydroxide | 0 | 0 | |
| Total | | 100 | 500 | |

Formula #8C - 2% Amcol B

| | | | Total | pH | Conductivity, |
|---|---|---|---|---|---|
| Phase | Ingredient | Weight, % | amount, gm | @20° C. | mS |
| A | Deionized water | To 100% | 170.5 | | 32.4 mS |
| A | Clay pre-gel | 2 | 167 | | |
| | (6% AMCOL B pre-gel) | | | | |
| B | AMMONYX ® DMCD-40 | 2.5 | 12.5 | | |
| | (40% active, 23% ethanol) | | | | |
| | Chemical name: lauramine oxide | | | | |
| B | Sodium xylene sulfonate | 12.5 | 62.5 | | |
| | (40% active) | | | | |
| B | TEA | 5 | 25 | | |
| C | DOWANOL DPnB | 5 | 25 | | |

| | | | | |
|---|---|---|---|---|
| C | DOWANOL EpH | 5 | 25 | pH = 10.24 before NaOH |
| D | Sodium silicate, ~40% active | 0 | 0 | pH = 12.69 after NaOH |
| E | 50% Sodium hydroxide | 2 | 10 | |
| Total | | 100 | 487.5 | |

Formula #13A - 2% Amcol (B + C)

| | | | Total | pH | Conductivity, |
|---|---|---|---|---|---|
| Phase | Ingredient | Weight, % | amount, gm | @20° C. | mS |
| A | Deionized water | To 100% | 119.16 | | 6.19 mS |
| A | Clay pre-gel | 2 | 218.34 | | |
| | (4.58% AMCOL (B + C) pre-gel) | | | | |
| B | AMMONYX ® DMCD-40 | 2.5 | 12.5 | | |
| | (40% active, 23% ethanol) | | | | |
| | Chemical name: lauramine oxide | | | | |
| B | Sodium xylene sulfonate | 12.5 | 62.5 | | |
| | (40% active) | | | | |
| B | TEA | 5 | 25 | | |
| C | DOWANOL DPnB | 5 | 25 | | |

| | | | | |
|---|---|---|---|---|
| C | DOWANOL EpH | 5 | 25 | pH = 10.84 before silicate |
| | | | | addition |
| D | Sodium silicate, ~40% active | 1.61 | 8.06 | pH = 11.49 after silicate |
| | | | | addition |
| E | 50% Sodium hydroxide | 0 | 0 | |
| Total | | 100 | 495.56 | |

Formula #13B - 2% Amcol (B + C)

| | | | Total | pH | Conductivity, |
|---|---|---|---|---|---|
| Phase | Ingredient | Weight, % | amount, gm | @20° C. | mS |
| A | Deionized water | To 100% | 96.05 | | 16.24 mS |
| A | Clay pre-gel | 2 | 176 | | |
| | (4.58% AMCOL (B + C) pre-gel) | | | | |
| B | AMMONYX ® DMCD-40 | 2.5 | 10.07 | | |
| | (40% active, 23% ethanol) | | | | |
| | Chemical name: lauramine oxide | | | | |
| B | Sodium xylene sulfonate | 12.5 | 50.38 | | |
| | (40% active) | | | | |
| B | TEA | 5 | 20.15 | | |
| C | DOWANOL DPnB | 5 | 20.15 | | |

| | | | | |
|---|---|---|---|---|
| C | DOWANOL EpH | 5 | 20.15 | pH = 10.72 before NaOH |
| | | | | addition |
| D | Sodium silicate, ~40% active | 0 | 0 | pH = 12.76 after NaOH |
| | | | | addition |
| E | 50% Sodium hydroxide | 2 | 10 | |
| Total | | 100 | 392.95 | |

Formula #10A - 1% Laponite based

| | | | Total amount, | pH | Conductivity, |
|---|---|---|---|---|---|
| Phase | Ingredient | Weight, % | gm | @20° C. | mS |
| A | Deionized water | To | 170.5 | | 12.89 mS |
| | | 100% | | | |
| A | pre-gel (3% Laponite RD pre-gel) | 1 | 167 | | |
| B | AMMONYX ® DMCD-40 | 2.5 | 12.5 | | |
| | (40% active, 23% ethanol) | | | | |
| | Chemical name: lauramine oxide | | | | |
| B | Sodium xylene sulfonate | 12.5 | 62.5 | | |
| | (40% active) | | | | |
| B | TEA | 5 | 25 | | |
| C | DOWANOL DPnB | 5 | 25 | | |

| | | | | |
|---|---|---|---|---|
| C | DOWANOL EpH | 5 | 25 | pH = 10.45 before |
| | | | | silicate |
| D | Sodium silicate, ~40% active | 2.5 | 12.5 | pH = 11.43 after silicate |
| E | 50% Sodium hydroxide | 0 | 0 | |
| Total | | 100 | 500 | |

Formula #10B - 2% Laponite based

| | | | Total | pH | Conductivity, |
|---|---|---|---|---|---|
| Phase | Ingredient | Weight, % | amount, gm | @20° C. | mS |
| A | Deionized water | To 100% | 170.5 | | 13.14 mS |
| A | Clay pre-gel | 1 | 167 | | |
| | (3% Laponite RD pre-gel) | | | | |
| B | AMMONYX ® DMCD-40 | 2.5 | 12.5 | | |
| | (40% active, 23% ethanol) | | | | |
| | Chemical name: lauramine oxide | | | | |
| B | Sodium xylene sulfonate | 12.5 | 62.5 | | |
| | (40% active) | | | | |
| B | TEA | 5 | 25 | | |
| C | DOWANOL DPnB | 5 | 25 | | |

| | | | | |
|---|---|---|---|---|
| C | DOWANOL EpH | 5 | 25 | pH = 10.35 before silicate |
| D | Sodium silicate, ~40% active | 2.5 | 12.5 | pH = 11.45 after silicate |
| E | 50% Sodium hydroxide | 0 | 0 | |
| Total | | 100 | 500 | |

Formula #10C - 2% Laponite based

| | | | Total | pH | Conductivity, |
|---|---|---|---|---|---|
| Phase | Ingredient | Weight, % | amount, gm | @20° C. | mS |
| A | Deionized water | To 100% | 170.5 | | 36.9 mS |
| A | Clay pre-gel | 1 | 167 | | |
| | (3% Laponite RD pre-gel) | | | | |
| B | AMMONYX ® DMCD-40 | 2.5 | 12.5 | | |
| | (40% active, 23% ethanol) | | | | |
| | Chemical name: lauramine oxide | | | | |
| B | Sodium xylene sulfonate | 12.5 | 62.5 | | |
| | (40% active) | | | | |
| B | TEA | 5 | 25 | | |
| C | DOWANOL DPnB | 5 | 25 | | |

| | | | | |
|---|---|---|---|---|
| C | DOWANOL EpH | 5 | 25 | pH = 10.52 before sodium |
| | | | | hydroxide |
| D | Sodium silicate, ~40% active | 0 | 0 | pH = 12.63 after sodium |
| | | | | hydroxide, quite thin |
| E | 50% Sodium hydroxide | 2 | 10 | |
| Total | | 100 | 487.5 | |

Formula #10D - 1% Laponite based

| | | | Total | pH | Conductivity, |
|---|---|---|---|---|---|
| Phase | Ingredient | Weight, % | amount, gm | @20° C. | mS |
| A | Deionized water | To 100% | 170.5 | | 32.5 mS |
| A | pre-gel (3% Laponite RD pre-gel) | 1 | 167 | | |
| B | AMMONYX ® DMCD-40 | 2.5 | 12.5 | | |
| | (40% active, 23% ethanol) | | | | |
| | Chemical name: lauramine oxide | | | | |
| B | Sodium xylene sulfonate | 12.5 | 62.5 | | |
| | (40% active) | | | | |
| B | TEA | 5 | 25 | | |
| C | DOWANOL DPnB | 5 | 25 | | |

| | | | | |
|---|---|---|---|---|
| C | DOWANOL EpH | 5 | 25 | pH = 10.27 before silicate |
| D | Sodium silicate, ~40% active | 2.5 | 12.5 | pH = 11.42 after silicate |
| | | | | pH = 12.93 after NaOH |
| E | 50% Sodium hydroxide | 2 | 10 | |
| Total | | 100 | 500 | |

### Spray Testing of First Set of Cleaner Formulations

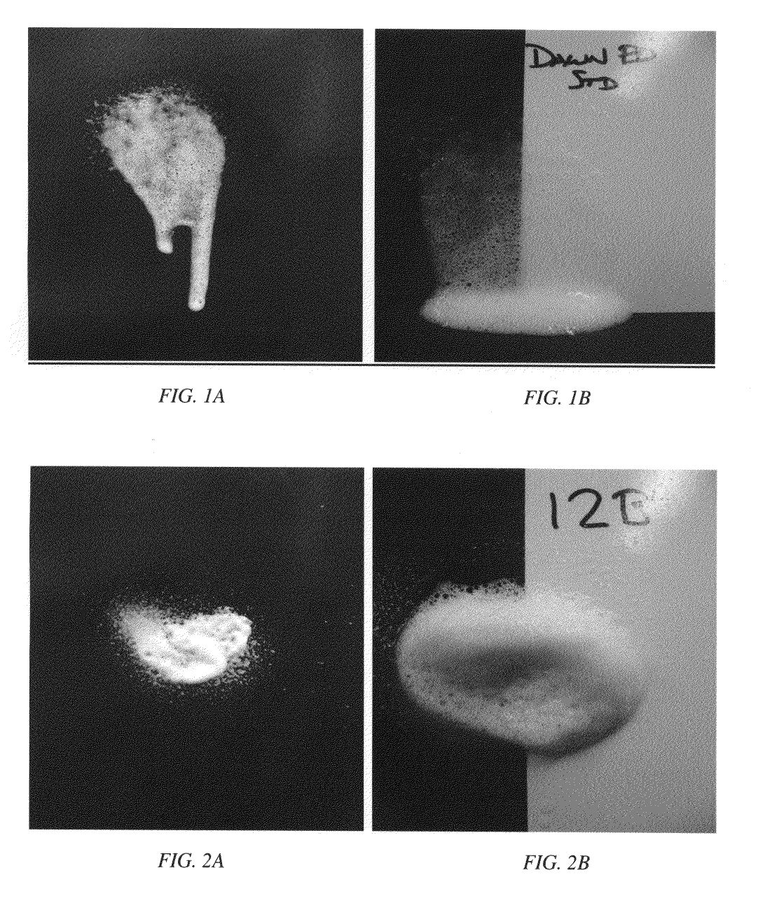

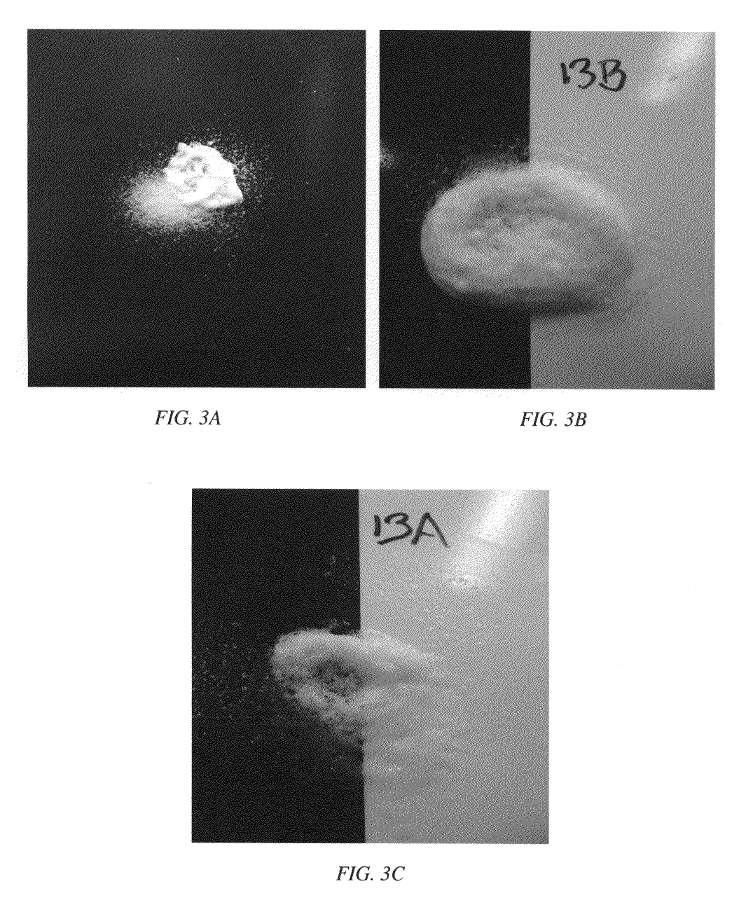

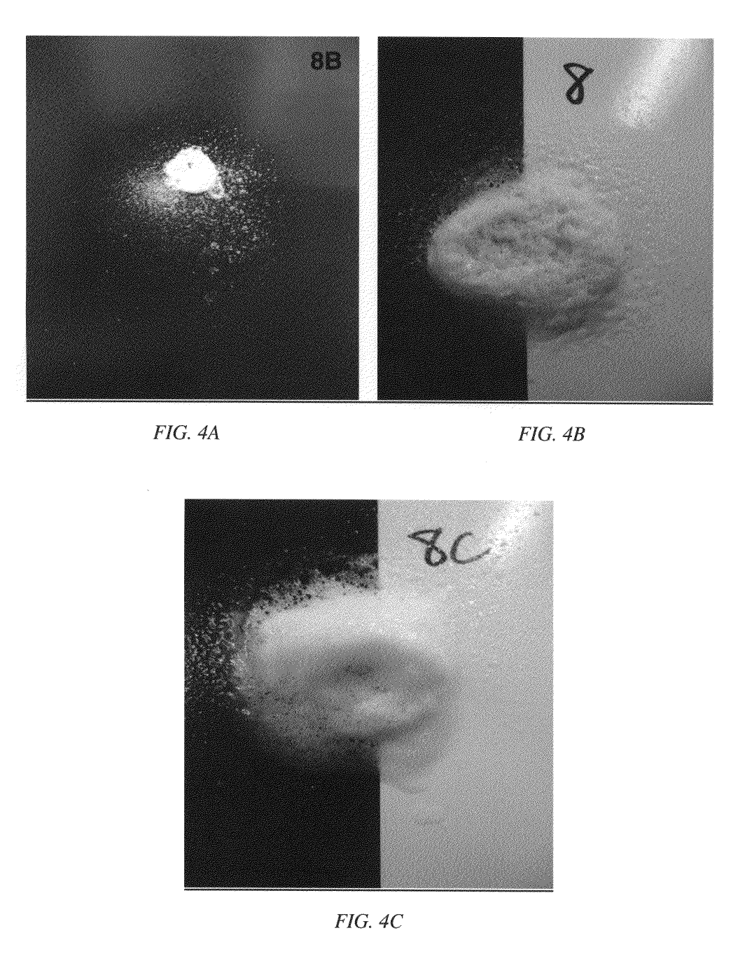

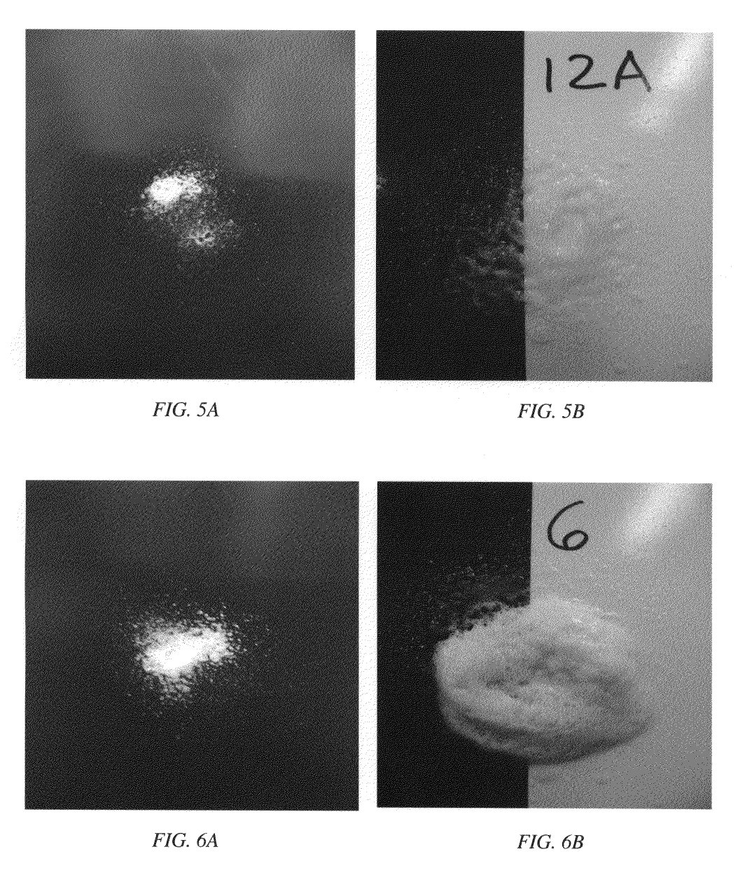

The formulations were filled in empty and clean containers having the same spray nozzle and then sprayed against a black vertical background from a fixed distance. The vertical surface was chosen to access the drip resistance of the formulations. The formulations were also sprayed a special coating paper with black and white contrasting backgrounds, to view the color of the foam against both colored backgrounds. Formulations were characterized by spray pattern and drip resistance. A range of spray patterns was observed (FIGS. 1-6) above, demonstrating the effect of solution viscosity. Thinner formulations had a wider spray pattern compared to the thicker formulations, where the spray is more concentrated in a smaller region. However, no dripping has been noticed from any of the AMCOL prototypes in this first set of formulations, at any viscosity level. This is a major improvement and differentiating factor over a commercial formula control, such as the Dawn Power Dissolver with a spray trigger. Also, it was found in this study that although the formulations using the pre-gels are colored beige or brown, the foam colors are slightly off-white to beige. It is possible to achieve almost white foams with clay based formulations, in some cases using very low (e.g., less than about 15% by weight, based on the weight of the clay or layered phyllosilicate in the composition, preferably less than about 10% by weight, more preferably less than about 6% by weight, and most preferably less than about 3% by weight) concentrations of optical whiteners, such as TiO₂ TINOPAL®SP (Ciba), UVITEX® OB (Ciba) or blue food grade colorings.

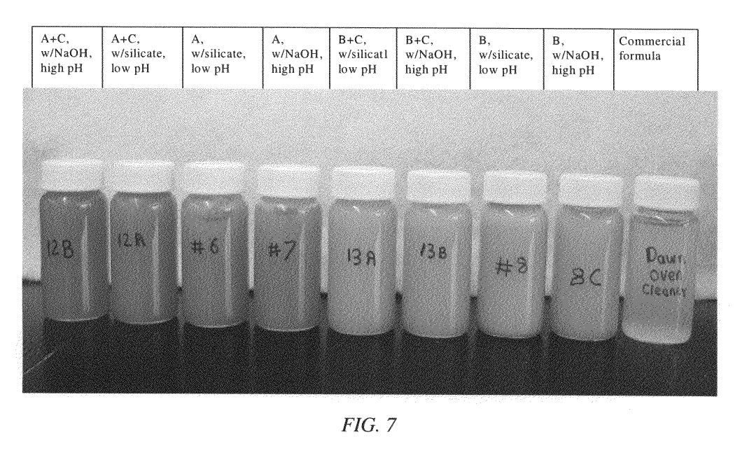

These formulations yielded slightly off-white to white foams against a white background, as observed in the Figures above, in spite of the colored formulations as shown in FIG. 7.

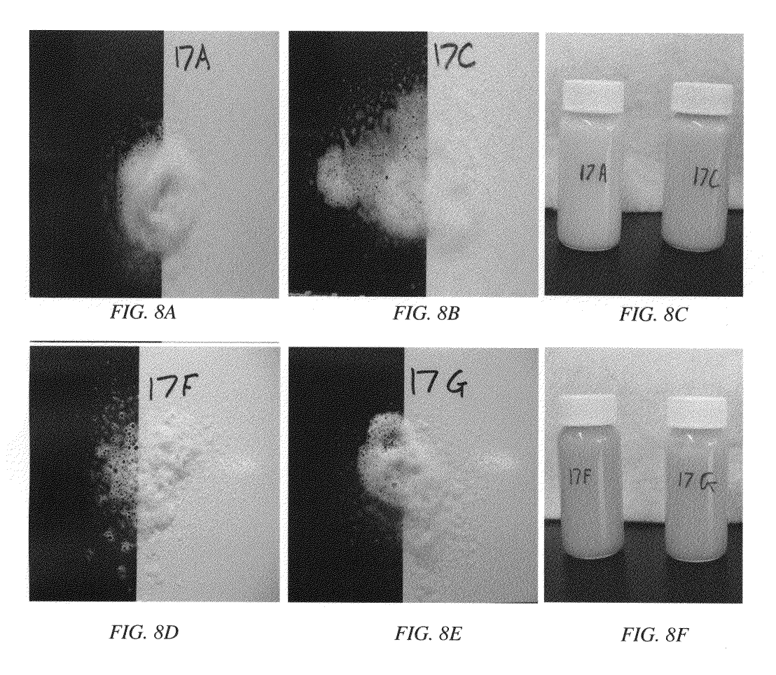

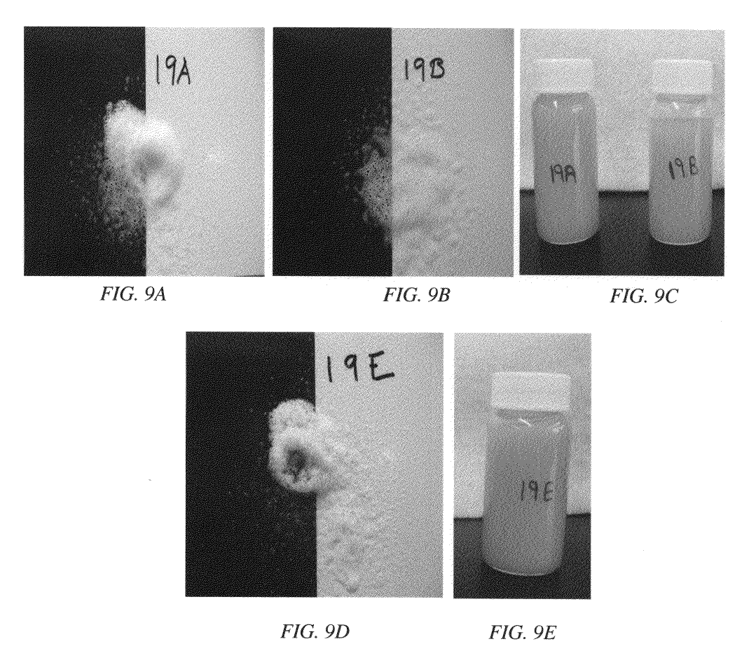

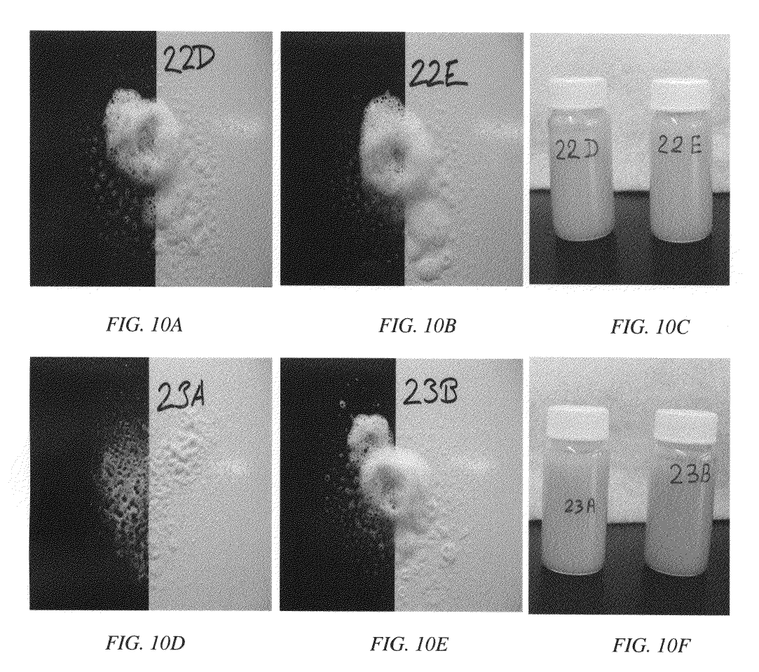

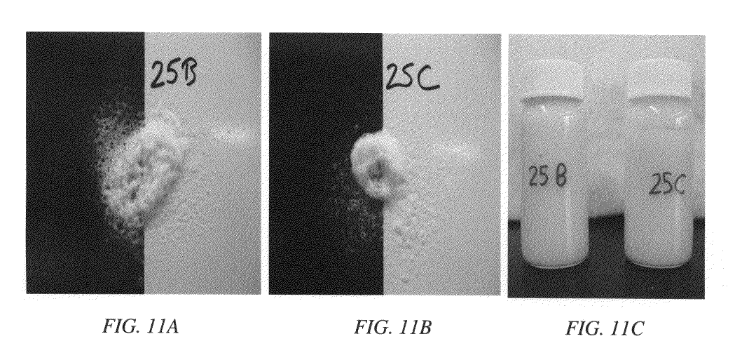

A second set of formulations was made to address the slight off-white to beige color of the foams against a white background. The approaches taken were four-fold: (a) use whiter or slight grey colored clays, (b) use mixtures of clays, (c) use TiO2 with clay mixtures, (d) use extended polymers with clays so as to be able to make formulations with less solids levels and thereby induce a lighter color to the foam. The foam pictures of these formulations are depicted in FIGS. 8-11.

The formulations containing different types of clay pre-gels individually and in mixtures, with and without polymers, TiO2 are listed in Table 3. The viscosity, sprayability and the foam characteristics in the wet and dry state for the same formulations in Table 3 are listed in Table 4. The color of the dry foam obtained from these formulations has been determined by Hunter Lab brightness monitor and is listed in Table 5a. Formulations in Table 3 have a wide range in concentration of clays, mixtures of clays, polymers and TiO2 and clearly demarcate the regions between stability/instability, sprayability/difficult to spray, and good foam/poor foam characteristics in terms of surface coverage and color. The stability of these samples is described in the Accelerated Stability Testing section. Based on the limits established in Tables 3, 4 on these parameters, an ideal set of formulations have been proposed in Table 5b. The detailed formulations in Table 5b are given.

TABLE 3
Set of exemplary formulations with different AMCOL pre-gel and additive compositions addressing foam color

| | | | | | Conc. of | | | | |
|---|---|---|---|---|---|---|---|---|---|
| | | | | | solids and | | | | |
| | | Alumino- | | Extended | polymer | | | pH after | Total |
| | A + B clays, | silicate, | | polymer, | % in | Silicate, | NaOH, | formu- | amount, |
| Sample | gm | gm | TiO2, gm | gm | formulation | gm | gm | lation | gm |
| 8BR1 AMCOL B w/ TiO2, 2.18% TiO2 on | | 4.008 | 0.0874 | | 2.05 | 5 | | 11.32 | 200 |
| clay | | | | | | | | | |
| 8CR1 AMCOL B w/ TiO2, 2.18% TiO2 on | | 4.008 | 0.0874 | | 2.06 | | 4 | 13.3 | 199 |
| clay | | | | | | | | | |
| 8D R1 AMCOL B w/ TiO2, 2.18% TiO2 on | | 4.008 | 0.0874 | | 2.01 | 5 | 4 | 13.38 | 204 |
| clay | | | | | | | | | |
| 16A AMCOL GP | | 4.008 | | | 2.00 | 5 | | 11.27 | 200 |
| 16B AMCOL GP | | 4.008 | | | 1.96 | 5 | 4 | 13.05 | 204 |
| 16C AMCOL GP with TiO2, 2.18% TiO2 on | | 4.008 | 0.0874 | | 2.05 | 5 | | 11.3 | 200 |
| clay | | | | | | | | | |
| 17A AMCOL GP + AMCOL B, 2.18% T O2 | | 4.008 | 0.0874 | | 2.05 | 5 | | 11.48 | 200 |
| on clay | | | | | | | | | |
| 17B AMCOL GP + AMCOL B, 2.18% T O2 | | 4.008 | 0.0874 | | 2.01 | 5 | 4 | 13.339 | 204 |
| on clay | | | | | | | | | |
| 17C AMCOL GP + AMCOL B, 2.18% T O2 | | 5.4 | 0.1177 | | 2.70 | 5 | 4 | 13.2 | 204 |
| on clay | | | | | | | | | |
| 17D (R1) AMCOL GPTiO2 + AMCOL B | 5.28 + 2.7 | 7.98 | 0.17396 | | 4.08 | 5 | | 11.29 | 200 |
| TiO2, 2.18% TiO2 on clay | | | | | | | | | |
| 17E AMCOL GP/TiO2 + AMCOL B/TiO2, | 5.28 + 2.7 | 7.98 | 0.17396 | | 4.00 | 5 | 4 | 13.119 | 204 |
| 2.18% TiO2 on clay | | | | | | | | | |
| 17 F AMCOL GP + AMCOL B | 5.28 + 2.7 | 7.98 | | | 3.99 | 5 | | 11.29 | 200 |
| 17 G AMCOL GP + AMCOL B | 5.28 + 2.7 | 7.98 | | | 3.91 | 5 | 4 | 13.25 | 204 |
| 17 M AMCOL GP/TiO2 + AMCOL B/TiO2 | 2.7 + 5.28 | 7.98 | 0.17396 | | 4.00 | 5 | 4 | 13.119 | 204 |
| 18A AMCOL (GP + C) | | 3.059 | | | 1.53 | 5 | | 11.71 | 200 |
| 18B AMCOL (GP + C) | | 3.059 | | | 1.50 | 5 | 4 | 13.3 | 204 |
| 19A AMCOL FLT | | 4.008 | | | 2.00 | 5 | | 11.67 | 200 |
| 19B AMCOL FLT | | 4.008 | | | 1.96 | 5 | 4 | 13.3 | 204 |
| 19C AMCOL FLT + AMCOL B | 6 + 1.98 | 7.98 | | | 3.99 | 5 | | 11.3 | 200 |
| 19 D AMCOL FLT + AMCOL B | | | | | 0.00 | 5 | 4 | 13.088 | 204 |
| 19E AMCOL FLT | 6 | 6 | | | 3.00 | 5 | | 11.348 | 200 |
| 19 F AMCOL FLT | 6 | 6 | | | 2.94 | 5 | 4 | 13.088 | 204 |
| 20A AMCOL (FLT + C) | | 3.059 | | | 1.53 | 5 | | 11.62 | 200 |
| 20B AMCOL (FLT + C) | | 3.059 | | | 1.50 | 5 | 4 | 13.3 | 204 |
| 21A (3% AMCOL (B + XP)), 0.25% exp on | | 3.99 | | 0.0099 | 1.96 | 5 | 4 | 13.15 | 204 |
| clay | | | | | | | | | |
| 21B (3% AMCOL (B + XP)), 0.25% exp on | | 1.995 | | 0.00498 | 1.00 | 5 | | 11.35 | 200 |
| clay | | | | | | | | | |
| 21C (3% AMCOL (B + XP)), 0.25% exp on | | 1.995 | | 0.00498 | 0.98 | 5 | 4 | 13.1 | 204 |
| clay | | | | | | | | | |
| 22A (6% AMCOL (GP + XP)), 0.15% XP on | | 4.008 | | 0.006 | 2.01 | 5 | | 11.376 | 200 |
| clay | | | | | | | | | |
| 22B (6% AMCOL (GP + XP)), 0.15% XP on | | 7.98 | | 0.01197 | 4.00 | 5 | | 11.349 | 200 |
| clay | | | | | | | | | |
| 22C (6% AMCOL (GP + XP)), 0.15% XP on | | 7.98 | | 0.01197 | 3.92 | 5 | 4 | 13.071 | 204 |
| clay | | | | | | | | | |
| 22D (6% AMCOL (GP + XP)) + (4% AMCOL | 6 + 1.32 | 7.32 | | 0.0123 | 3.67 | 5 | | 11.11 | 200 |
| (B + XP)), 0.15% XP on AMCOL GP& 0.25% | | | | | | | | | |
| XP on AMCOL B | | | | | | | | | |
| 22E (6% AMCOL (GP + XP)) + (4% AMCOL | 6 + 1.32 | 7.32 | | 0.0123 | 3.59 | 5 | 4 | 13.17 | 204 |
| (B + XP)), 0.15% XP on AMCOL GP& 0.25% | | | | | | | | | |
| XP on AMCOL B | | | | | | | | | |
| 23A AMCOL GP + AMCOL FLT | 5.28 + 2.7 | 7.98 | | | 3.99 | 5 | | 11.262 | 200 |
| 23B AMCOL GP + AMCOL FLT | 5.28 + 2.7 | 7.98 | | | 3.91 | 5 | 4 | 13.136 | 204 |
| 25A AMCOL(B + C)/TiO2, | | 3.059 | 0.13365 | | 1.60 | 5 | | 11.494 | 200 |
| 5% TiO2 on clay | | | | | | | | | |
| 25B AMCOL(B + C)/TiO2, 5% TiO2 on clay | | 4.122 | 0.18 | | 2.15 | 5 | | 11.52 | 200 |
| 25C AMCOL(B + C)/TiO2, 5% TiO2 on clay | | 4.122 | 0.18 | | 2.11 | 5 | 4 | 13.222 | 204 |

TABLE 4
Viscosity, sprayability and foam characteristics of Table 3 formulations

| | | | | Degree | | | | |
|---|---|---|---|---|---|---|---|---|
| | | | | of shear | | | | |
| | | | | thinning = | | | | |
| | | Vis- | Vis- | Visc | | Liquid | | |
| | | cosity | cosity | at 0.5/ | | stage | | |
| | Viscosity | at | at | Visc. | | Foam | | |
| Sample | at 0.5 rpm | 0.1 rpm | 200 rpm | at 200 | Sprayability | quality | Dry stage foam color | Drip |
| 8BR1 AMCOL B w/ TiO2, 2.18% | 24800.00 | 200000.00 | 255.00 | 97.25 | good | good | | no |
| TiO2 on clay | | | | | | | | |
| 8CR1 AMCOL B w/ TiO2, 2.18% | 41200.00 | 198000.00 | 299.00 | 137.79 | good | good | beige residue | no |
| TiO2 on clay | | | | | | | | |
| 8D R1 AMCOL B w/ TiO2, 2.18% | 14400.00 | 226000.00 | 258.00 | 55.81 | good | good | off-white residue | no |
| TiO2 on clay | | | | | | | | |

8D(R1) > 8C (R1), 8B (R1)

| | | | | | | | | |
|---|---|---|---|---|---|---|---|---|
| 16A AMCOL GP | 1000.00 | 8000.00 | 60.00 | 16.67 | good | | white | |
| 16B AMCOL GP | 2000.00 | 13000 | 62.00 | 32.26 | good | | white | |
| 16C AMCOL GPwith TiO2, | | | | | | | 16B > 16A | |
| 2.18% TiO2 on clay | | | | | | | | |
| 17A AMCOL GP + AMCOL B, | 17200.00 | 132000.00 | 149.00 | 115.44 | good | good, | white, very sl. Grey | no |
| 2.18% T O2 on clay | | | | | | white | | |
| 17B AMCOL GP + AMCOL B, | 10800.00 | 46000.00 | 246.00 | 43.90 | good | ok, white | almost white | yes |
| 2.18% T O2 on clay | | | | | | | | |
| 17C AMCOL GP + AMCOL B, | 27600.00 | 130000.00 | 506.00 | 54.55 | good | good, | almost white | slight |
| 2.18% T O2 on clay | | | | | | off-white | | |
| 17D (R1) AMCOL GPTiO2 + | 87600.00 | 667000.00 | 440.00 | 199.09 | difficult to spray | good, | white, very sl. Grey | no |
| AMCOL B TiO2, 2.18% TiO2 on | | | | | | white | | |
| clay | | | | | | | | |
| 17E AMCOL GP/TiO2 + AMCOL | 76000.00 | 368000.00 | 750.00 | 101.33 | difficult to spray | good, | almost white | no |
| B/TiO2, 2.18% TiO2 on clay | | | | | | white | | |
| 17 F AMCOL GP + AMCOL B | 65600.00 | 506000.00 | 512.00 | 128.13 | difficult to spray | good, | almost white | no |
| | | | | | | white | | |
| 17 G AMCOL GP + AMCOL B | 30800.00 | 154000.00 | 626.00 | 49.20 | difficult to spray | good, | almost white | slight |
| | | | | | | white | | |
| 17 M AMCOL GP/TiO2 + | 90800.00 | 429000.00 | 550.00 | 165.09 | too thick to spray | | | |
| AMCOL B/TiO2 | | | | | | | | |

17B > 17C > 17A

| | | | | | | | | |
|---|---|---|---|---|---|---|---|---|
| 18A AMCOL (GP + C) | 1200.00 | 10000.00 | 46.00 | 26.09 | good | | | |
| 18B AMCOL (GP + C) | 800.00 | 8000.00 | 44.00 | 18.18 | good | | | |
| 19A AMCOL FLT | 11200.00 | 36000.00 | 101.00 | 110.89 | good, white | good, | quite grey residue | no |
| | | | | | | beautiful | | |
| | | | | | | white | | |
| 19B AMCOL FLT | 5200.00 | 20000.00 | 175.00 | 29.71 | good, white | ok | white to sl. off-white | slight |
| | | | | | | | residue | |
| 19C AMCOL FLT + AMCOL B | 40600.00 | 396000.00 | 550.00 | 73.82 | too thick to spray- | | | |
| | | | | | did not spray | | | |
| 19 D AMCOL FLT + AMCOL B | 66400.00 | 316000.00 | 550.00 | 120.73 | too thick to spray- | | | |
| | | | | | did not spray | | | |
| 19E AMCOL FLT | 11200.00 | 48000.00 | 184.50 | 60.70 | barely able to | ok | greyish white residue | slight |
| | | | | | spray, white | | | |
| 19 F AMCOL FLT | 30600.00 | 92000.00 | 450.50 | 67.92 | barely able to | | | |
| | | | | | spray | | | |

19B > 19A

| | | | | | | | | |
|---|---|---|---|---|---|---|---|---|
| 20A AMCOL (FLT + C) | 5200.00 | 16000.00 | 59.00 | 88.14 | good, white | good | sl. Greyish white residue | yes |
| 20B AMCOL (FLT + C) | 1000.00 | 3000.00 | 50.40 | 19.84 | good, white | ok | sl. Greyish white residue | yes |

20B > 20A

| | | | | | | | | |
|---|---|---|---|---|---|---|---|---|
| 21A (3% AMCOL (B + XP)), | 1400.00 | 4000.00 | 72.00 | 19.44 | good, beige | good | beige residue | moderate |
| 0.25% exp on clay | | | | | | | | |
| 21B (3% AMCOL (B + XP)), | 400.00 | 2000.00 | 42.00 | 9.52 | good, white | ok | white residue | yes |
| 0.25% exp on clay | | | | | | | | |
| 21C (3% AMCOL (B + XP)), | 600.00 | 6000.00 | 63.00 | 9.52 | good | | | |
| 0.25% exp on clay | | | | | | | | |

21B > 21A

| | | | | | | | | |
|---|---|---|---|---|---|---|---|---|
| 22A (6% AMCOL (GP + XP)), | 2800.00 | 12000.00 | 107.00 | 26.17 | good, white | ok | white | yes |
| 0.15% XP on clay | | | | | | | | |
| 22B (6% AMCOL (GP + XP)), | 26000.00 | 130000.00 | 258.00 | 100.78 | good, white | good | slight grey | moderate |
| 0.15% XP on clay | | | | | | | | |
| 22C (6% AMCOL (GP + XP)), | 5600.00 | 18000.00 | 79.00 | 70.89 | good, white | ok | almost transparent white | yes |
| 0.15% XP on clay | | | | | | | residue | |
| 22D (6% AMCOL (GP + XP)) + | 19200.00 | 93000.00 | 206.00 | 93.20 | good, white | good | sl. Grey-white foam | no |
| (4% AMCOL (B + XP)), 0.15% | | | | | | | | |
| XP on AMCOL GP& 0.25% | | | | | | | | |
| XP on AMCOL B | | | | | | | | |
| 22E (6% AMCOL (GP + XP)) + | 3600.00 | 27000.00 | 251.50 | 14.31 | good, white | good | white | slight |
| (4% AMCOL (B + XP)), 0.15% | | | | | | | | |
| XP on AMCOL GP& 0.25% | | | | | | | | |
| XP on AMCOL B | | | | | | | | |

22A > 22C > 22B > 22E > 22D

| | | | | | | | | |
|---|---|---|---|---|---|---|---|---|
| 23A AMCOL GP + AMCOL FLT | 21800.00 | 118000.00 | 137.00 | 159.12 | difficult to spray, | poor | slight off-white | no |
| | | | | | off-white | | | |
| 23B AMCOL GP + AMCOL FLT | 19600.00 | 83000.00 | 344.50 | 56.89 | good, white | good | slight grey | slight |

23B > 23A

| | | | | | | | | |
|---|---|---|---|---|---|---|---|---|
| 25A AMCOL(B + C)/TiO2, 5% | 33000.00 | 170000.00 | 159.50 | 206.90 | good, white | good | sl. Greyish white residue | slight |
| TiO2 on clay | | | | | | | | |
| 25B AMCOL(B + C)/TiO2, 5% | 60600.00 | 250000.00 | 249.00 | 243.37 | good, white | good | sl. Greyish white residue | no |
| TiO2 on clay | | | | | | | | |
| 25C AMCOL(B + C)/TiO2, 5% | 44600.00 | 206000.00 | 340.00 | 131.18 | difficult to spray, | ok | sl. Greyish white residue | no |
| TiO2 on clay | | | | | white | | | |

25A > 25B > 25C

TABLE 5a
Hunter lab method for monitoring the lightness and color of dry foams
from cleaner formulations prepared with the new AMCOL
aluminosilicate pre-gels on the BYK Gardner coating paper

| Sample ID | L | a | b |
|---|---|---|---|
| 17A Test 01 w black backing | 87.22 | −0.62 | 6.79 |
| 17B Test 01 w black backing | 89.35 | −0.95 | 6.22 |
| 17F Test 01 w black backing | 87.69 | −0.84 | 7.16 |
| 17G Test 01 w black backing | 87.50 | −0.81 | 8.13 |
| 19A Test 01 w black backing | 88.49 | −0.95 | 6.06 |
| 19B Test 01 w black backing | 89.50 | −1.18 | 5.74 |
| 22D Test 01 w black backing | 88.27 | −1.07 | 6.03 |
| 22E Test 01 w black backing | 88.87 | −1.00 | 6.58 |
| 23A Test 01 w black backing | 87.51 | −0.22 | 8.92 |
| 23B Test 01 w black backing | 87.34 | −1.07 | 7.52 |
| 25A Test 01 w black blacking | 87.96 | −0.49 | 6.58 |
| 25B Test 01 w black backing | 85.67 | 0.33 | 8.59 |
| 25C Test 01 w black backing | 88.41 | −0.46 | 7.14 |
| 8CR1 Test 01 w black backing | 84.79 | 0.84 | 11.20 |
| 8D Test 01 w black backing | 87.77 | −0.27 | 8.74 |
| BYK Coating Paper-Test 01 (Control) | 90.53 | −1.08 | 3.51 |

L = measure of lightness, 100% means white and 0% means black
+a = redness,
0 = gray,
−a = greenness;
+b = indicates yellowness,
0 for gray, −b = blueness

TABLE 5b
Proposed set of exemplary formulations with the optimum viscosity, sprayability, foam characteristics and stability

| | | | | | Conc. of | | | | |
|---|---|---|---|---|---|---|---|---|---|
| | | Alumino- | | Extended | solids and | | | | Total |
| | A + B clays, | silicate, | | polymer, | polymer % in | Silicate, | NaOH, | pH after | amount, |
| Sample | gm | gm | TiO2, gm | gm | formulation | gm | gm | formulation | gm |
| 8B (R2) AMCOL B w/ TiO2, 2.18% | | 4.008 | 0.2004 | | 2.10 | 5 | | 11.32 | 200 |
| TiO2 on clay | | | | | | | | | |
| 8D (R2) AMCOL B w/ TiO2, 2.18% | | 4.008 | 0.2004 | | 2.10 | 5 | 4 | 13.38 | 200 |
| TiO2 on clay | | | | | | | | | |
| 17A (R1) AMCOL GP + AMCOL B, | 2.7 + 2.7 | 5.4 | 0.1399 | | 2.77 | 5 | 4 | 13.119 | 200 |
| 2.18% T O2 on clay | | | | | | | | | |
| 17C (R1) AMCOL GP + AMCOL B, | 2.7 + 2.7 | 5.4 | 0.1399 | | 2.77 | 5 | 4 | 13.119 | 200 |
| 2.18% T O2 on clay | | | | | | | | | |
| 17 F (R1) AMCOL GP + AMCOL B | 2.7 + 2.7 | 5.4 | | | 2.70 | 5 | 4 | 13.119 | 200 |
| 17 G (R1) AMCOL GP + AMCOL B | 2.7 + 2.7 | 5.4 | | | 2.70 | 5 | 4 | 13.119 | 200 |
| 19A (R1) AMCOL FLT | | 5.04 | | | 2.52 | 5 | | 11.67 | 200 |
| 19B (R1) AMCOL FLT | | 5.04 | | | 2.52 | 5 | 4 | 13.3 | 200 |
| 22D (R1) (6% AMCOL (GP + XP)) + | 5.28 + 1.8 | 7.08 | 0.054 | 0.0124 | 3.57 | 5 | | 11.11 | 200 |
| (4% AMCOL (B + XP)), | | | | | | | | | |
| 0.15% XP on AMCOL GP& 0.25% | | | | | | | | | |
| XP on AMCOL B | | | | | | | | | |
| 22E (R1) (6% AMCOL (GP + XP)) + | 5.28 + 1.8 | 7.08 | 0.054 | 0.0124 | 3.57 | 5 | 4 | 13.17 | 200 |
| (4% AMCOL (B + XP)), | | | | | | | | | |
| 0.15% XP on AMCOL GP& 0.25% | | | | | | | | | |
| XP on AMCOL B | | | | | | | | | |
| 23A (R1) AMCOL GP + AMCOL | 5.49 + 2.28 | 7.77 | | | 3.89 | 5 | | 11.262 | 200 |
| FLT | | | | | | | | | |
| 23B (R1) AMCOL GP + AMCOL | 5.49 + 2.28 | 7.77 | | | 3.89 | 5 | 4 | 13.136 | 200 |
| FLT | | | | | | | | | |
| 25B (R1) AMCOL(B + C)/TiO2, 5% | | 3.89 | 0.17 | | 2.03 | 5 | 4 | 13.222 | 200 |
| TiO2 on clay | | | | | | | | | |
| 25C (R1) AMCOL(B + C)/TiO2, 5% | | 3.89 | 0.17 | | 2.03 | 5 | 4 | 13.222 | 200 |
| TiO2 on clay | | | | | | | | | |

Detailed formulation descriptions for Table 5 are provided below.

### Formula #8B(R2)—2% AMCOL B Based

| | | | Total | |
|---|---|---|---|---|
| | | | amount, | |
| Phase | Ingredient | Weight, % | gm | pH @25° C. |
| A | Deionized water | To 100% | 133.06 | |
| A | Aluminosilicate pre-gel | 33.4 | 133.6 | 2.10% (w/w) |
| | (6% AMCOL B pre-gel with | | | |
| | 5% TiO2 on aluminosilicate) | | | solids |
| B | Ammonyx LO (30% active) | 3.33 | 13.34 | |
| | Chemical name: lauramine | | | |
| | oxide | | | |
| B | Sodium xylene sulfonate | 12.5 | 50 | |
| | (40% active) | | | |
| B | TEA | 5 | 20 | |
| C | Dowanol DPnB | 5 | 20 | |
| C | Dowanol EpH | 5 | 20 | pH = 10.35 |
| | | | | before |
| | | | | silicate |
| D | Sodium silicate, ~40% | 2.5 | 10 | pH = 11.32 |
| | active | | | after |
| | | | | silicate |
| E | 50% Sodium hydroxide | 0 | 0 | |
| Total | | 100 | 400 | |

### Formula #8C(R2)—2% AMCOL B Based

| | | | Total | |
|---|---|---|---|---|
| | | | amount, | |
| Phase | Ingredient | Weight, % | gm | pH @25° C. |
| A | Deionized water | To 100% | 135.06 | |
| A | Aluminosilicate pre-gel | 33.4 | 133.6 | 2.10% (w/w) |
| | (6% AMCOL B pre-gel with | | | solids |
| | 5% TiO2 on aluminosilicate) | | | |
| B | Ammonyx LO (30% active) | 3.33 | 13.34 | |
| | Chemical name: lauramine | | | |
| | oxide | | | |
| B | Sodium xylene sulfonate | 12.5 | 50 | |
| | (40% active) | | | |
| B | TEA | 5 | 20 | |
| C | Dowanol DPnB | 5 | 20 | |
| C | Dowanol EpH | 5 | 20 | |
| D | Sodium silicate, ~40% active | 0 | 0 | |
| E | 50% Sodium hydroxide | 2 | 8 | pH = 13.3 |
| Total | | 100 | 400 | |

### Formula #8D(R2)—2% AMCOL B Based

| | | | Total | |
|---|---|---|---|---|
| | | | amount, | |
| Phase | Ingredient | Weight, % | gm | pH @25° C. |
| A | Deionized water | To 100% | 125.06 | |
| A | Aluminosilicate pre-gel (6% | 33.4 | 133.6 | 2.10% (w/w) |
| | AMCOL B pre-gel with 5% | | | solids |
| | TiO2 on aluminosilicate) | | | |
| B | Ammonyx LO (30% active) | 3.33 | 13.34 | |
| | Chemical name: lauramine | | | |
| | oxide | | | |
| B | Sodium xylene sulfonate | 12.5 | 50 | |
| | (40% active) | | | |
| B | TEA | 5 | 20 | |
| C | Dowanol DPnB | 5 | 20 | |
| C | Dowanol EpH | 5 | 20 | |
| D | Sodium silicate, ~40% active | 2.5 | 10 | |
| E | 50% Sodium hydroxide | 2 | 8 | pH = 13.38 |
| Total | | 100 | 400 | |

### Formula #25B(R1)—1.945% AMCOL (B+C) Based

| | | | Total | |
|---|---|---|---|---|
| Phase | Ingredient | Weight, % | amount, gm | pH @25° C. |
| A | Deionized water | To 100% | 96.66 | |
| A | Aluminosilicate pre-gel | 42.5 | 170 | 2.03% (w/w) |
| | (4.58% AMCOL (B + C) | | | solids |
| | pre-gel) with 5% TiO2 | | | |
| | on aluminosilicate B | | | |
| B | Ammonyx LO (30% | 3.33 | 13.34 | |
| | active) Chemical name: | | | |
| | lauramine oxide | | | |
| B | Sodium xylene | 12.5 | 50 | |
| | sulfonate (40% active) | | | |
| B | TEA | 5 | 20 | |
| B | Dowanol DPnB | 5 | 20 | |
| | Dowanol EpH | 5 | 20 | |
| C | Sodium silicate, ~40% | 2.5 | 10 | pH = 11.52 |
| | active | | | |
| C | | | | |
| D | 50% Sodium hydroxide | | | |
| Total | | 100 | 400 | |

### Formula #25C(R1)—1.945% AMCOL (B+C) Based

| | | | Total | |
|---|---|---|---|---|
| | | | amount, | |
| Phase | Ingredient | Weight, % | gm | pH @25° C. |
| A | Deionized water | To 100% | 88.66 | |
| A | Aluminosilicate pre-gel | 42.5 | 170 | 2.03% (w/w) |
| | (4.58% AMCOL (B + C) pre- | | | solids |
| | gel) with 5% TiO2 on | | | |
| | aluminosilicate B | | | |
| B | Ammonyx LO (30% active) | 3.33 | 13.34 | |
| | Chemical name: lauramine | | | |
| | oxide | | | |
| B | Sodium xylene sulfonate | 12.5 | 50 | |
| | (40% active) | | | |
| B | TEA | 5 | 20 | |
| B | Dowanol DPnB | 5 | 20 | |
| | Dowanol EpH | 5 | 20 | |
| C | Sodium silicate, ~40% active | 2.5 | 10 | |
| C | | | | |
| D | 50% Sodium hydroxide | 2 | 8 | pH = 13.222 |
| Total | | 100 | 400 | |

Formula #17A (R1)—2.7% AMCOL GP/AMCOL B with TiO2 Based

| | | | Total | |
|---|---|---|---|---|
| | | | amount, | |
| Phase | Ingredient | Weight, % | gm | pH @25° C. |
| A | Deionized water | To 100% | 86.66 | |
| A | Aluminosilicate pre-gel | 45 | 180 | 2.77% (w/w) |
| | (6% AMCOL GPwith 2.18% | | | solids |
| | TiO2 on aluminosilicate + 6% | | | |
| | AMCOL B with 3% TiO2 on | | | |
| | aluminosilicate in 1:1 ratio) | | | |
| B | Ammonyx LO (30% active) | 3.33 | 13.34 | |
| | Chemical name: lauramine | | | |
| | oxide | | | |
| B | Sodium xylene sulfonate | 12.5 | 50 | |
| | (40% active) | | | |
| B | TEA | 5 | 20 | |
| B | Dowanol DPnB | 5 | 20 | |
| | Dowanol EpH | 5 | 20 | |
| C | Sodium silicate, ~40% active | 2.5 | 10 | pH = 111.48 |
| C | | | | |
| D | 50% Sodium hydroxide | | | |
| Total | | 100 | 400 | |

Formula #17C(R1)—2.7% AMCOL GP/AMCOL B with TiO2 Based

| | | | Total | |
|---|---|---|---|---|
| | | | amount, | |
| Phase | Ingredient | Weight, % | gm | pH @25° C. |
| A | Deionized water | To 100% | 78.66 | |
| A | Aluminosilicate pre-gel (6% | 45 | 180 | 2.77% (w/w) |
| | AMCOL GPwith 2.18% TiO2 | | | solids |
| | on aluminosilicate + 6% | | | |
| | AMCOL B with 3% TiO2 on | | | |
| | aluminosilicate in 1:1 ratio) | | | |
| B | Ammonyx LO (30% active) | 3.33 | 13.34 | |
| | Chemical name: lauramine | | | |
| | oxide | | | |
| B | Sodium xylene sulfonate | 12.5 | 50 | |
| | (40% active) | | | |
| B | TEA | 5 | 20 | |
| B | Dowanol DPnB | 5 | 20 | |
| | Dowanol EpH | 5 | 20 | |
| C | Sodium silicate, ~40% active | 2.5 | 10 | |
| C | | | | |
| D | 50% Sodium hydroxide | 2 | 8 | pH = 13.2 |
| Total | | 100 | 400 | |

### Formula #17F (R1)—2.7% AMCOL GP/AMCOL B Based

| | | | Total | |
|---|---|---|---|---|
| | | | amount, | |
| Phase | Ingredient | Weight, % | gm | pH @25° C. |
| A | Deionized water | To 100% | 86.66 | |
| A | Aluminosilicate pre-gel (6% | 45 | 180 | 2.7% (w/w) |
| | AMCOL GP + 6% AMCOL | | | solids |
| | B in 1:1 ratio) | | | |
| B | Ammonyx LO (30% active) | 3.33 | 13.34 | |
| | Chemical name: lauramine | | | |
| | oxide | | | |
| B | Sodium xylene sulfonate | 12.5 | 50 | |
| | (40% active) | | | |
| B | TEA | 5 | 20 | |
| B | Dowanol DPnB | 5 | 20 | |
| | Dowanol EpH | 5 | 20 | |
| C | Sodium silicate, ~40% active | 2.5 | 10 | pH = 11.29 |
| C | | | | |
| D | 50% Sodium hydroxide | | | |
| Total | | 100 | 400 | |

### Formula #17G (R1)—2.7% AMCOL GP/AMCOL B Based

| | | | Total | |
|---|---|---|---|---|
| | | | amount, | |
| Phase | Ingredient | Weight, % | gm | pH @25° C. |
| A | Deionized water | To 100% | 78.66 | |
| A | Aluminosilicate pre-gel (6% | 45 | 180 | 2.7% (w/w) |
| | AMCOL GP + 6% AMCOL | | | solids |
| | B in 1:1 ratio) | | | |
| B | Ammonyx LO (30% active) | 3.33 | 13.34 | |
| | Chemical name: lauramine | | | |
| | oxide | | | |
| B | Sodium xylene sulfonate | 12.5 | 50 | |
| | (40% active) | | | |
| B | TEA | 5 | 20 | |
| B | Dowanol DPnB | 5 | 20 | |
| | Dowanol EpH | 5 | 20 | |
| C | Sodium silicate, ~40% active | 2.5 | 10 | |
| C | | | | |
| D | 50% Sodium hydroxide | 2 | 8 | pH = 13.25 |
| Total | | 100 | 400 | |

### Formula #19A (R1)—2.52% AMCOL FLT Based

| | | | Total | |
|---|---|---|---|---|
| | | | amount, | |
| Phase | Ingredient | Weight, % | gm | pH @25° C. |
| A | Deionized water | To 100% | 98.66 | |
| A | Aluminosilicate pre-gel | 42 | 168 | 2.52% (w/w) |
| | (6% AMCOL FLT) | | | solids |
| B | Ammonyx LO (30% active) | 3.33 | 13.34 | |
| | Chemical name: lauramine | | | |
| | oxide | | | |
| B | Sodium xylene sulfonate | 12.5 | 50 | |
| | (40% active) | | | |
| B | TEA | 5 | 20 | |
| B | Dowanol DPnB | 5 | 20 | |
| | Dowanol EpH | 5 | 20 | |
| C | Sodium silicate, ~40% active | 2.5 | 10 | pH = 11.67 |
| C | | | | |
| D | 50% Sodium hydroxide | | | |
| Total | | 100 | 400 | |

### Formula #19B (R1)—2.52% AMCOL FLT Based

| | | | Total | |
|---|---|---|---|---|
| | | | amount, | |
| Phase | Ingredient | Weight, % | gm | pH @25° C. |
| A | Deionized water | To 100% | 90.66 | |
| A | Aluminosilicate Pre-gel (6% | 42 | 168 | 2.52% (w/w) |
| | AMCOL FLT) | | | solids |
| B | Ammonyx LO (30% active) | 3.33 | 13.34 | |
| | Chemical name: lauramine | | | |
| | oxide | | | |
| B | Sodium xylene sulfonate | 12.5 | 50 | |
| | (40% active) | | | |
| B | TEA | 5 | 20 | |
| B | Dowanol DPnB | 5 | 20 | |
| | Dowanol EpH | 5 | 20 | |
| C | Sodium silicate, ~40% active | 2.5 | 10 | |
| C | | | | |
| D | 50% Sodium hydroxide | 2 | 8 | pH = 13.30 |
| Total | | 100 | 400 | |

Formula #22D (R1)—3.54% AMCOL (GP+XP)+AMCOL (B+XP) with TiO2 on B

| Phase | Ingredient | Weight, % | Total amount, gm | pH @25° C. |
|---|---|---|---|---|
| A | Deionized water | To 100% | 98.66 | |
| A | Aluminosilicate Pre-gel (6.01% | 42 | 168 | 3.57% (w/w) solids |
| | AMCOL (GP + XP) + 4.009% | | | |
| | AMCOL (B + XP) and 3% TiO2 | | | |
| | on AMCOL B) ratio or | | | |
| | (GP + XP):(B + XP) = 1.956:1 | | | |
| B | Ammonyx LO (30% active) | 3.33 | 13.34 | |
| | Chemical name: lauramine oxide | | | |
| B | Sodium xylene sulfonate (40% | 12.5 | 50 | |
| | active) | | | |
| B | TEA | 5 | 20 | |
| B | Dowanol DPnB | 5 | 20 | |
| | Dowanol EpH | 5 | 20 | |
| C | Sodium silicate, ~40% active | 2.5 | 10 | pH = 11.11 |
| C | | | | |
| D | 50% Sodium hydroxide | | | |
| Total | | 100 | 400 | |

Formula #22E (R1)—3.54% AMCOL (GP+XP)+AMCOL (B+XP) with TiO2 on B

| Phase | Ingredient | Weight, % | Total amount, gm | pH @25° C. |
|---|---|---|---|---|
| A | Deionized water | To 100% | 90.66 | |
| A | Aluminosilicate Pre-gel (6.01% | 42 | 168 | 3.57% (w/w) solids |
| | AMCOL (GP + XP) + 4.009% | | | |
| | AMCOL (B + XP) and 3% TiO2 | | | |
| | on AMCOL B) ratio or | | | |
| | (GP + XP):(B + XP) = 1.956:1 | | | |
| B | Ammonyx LO (30% active) | 3.33 | 13.34 | |
| | Chemical name: lauramine | | | |
| | oxide | | | |
| B | Sodium xylene sulfonate (40% | 12.5 | 50 | |
| | active) | | | |
| B | TEA | 5 | 20 | |
| B | Dowanol DPnB | 5 | 20 | |
| | Dowanol EpH | 5 | 20 | |
| C | Sodium silicate, ~40% active | 2.5 | 10 | |
| C | | | | |
| D | 50% Sodium hydroxide | 2 | 8 | pH = 13.17 |
| Total | | 100 | 400 | |

### Formula #23A (R1)—3.89% AMCOL GP/AMCOL FLT Based

| Phase | Ingredient | Weight, % | Total amount, gm | pH @25° C. |
|---|---|---|---|---|
| A | Deionized water | To 100% | 7.66 | |
| A | Aluminosilicate pre-gel (6% AMCOL | 64.75 | 259 | 3.89% (w/w) solids |
| | GP: 6% AMCOL FLT = 2.5) | | | |
| B | Ammonyx LO (30% active) | 3.33 | 13.34 | |
| | Chemical name: lauramine oxide | | | |
| B | Sodium xylene sulfonate (40% active) | 12.5 | 50 | |
| B | TEA | 5 | 20 | |
| B | Dowanol DPnB | 5 | 20 | |
| | Dowanol EpH | 5 | 20 | |
| C | Sodium silicate, ~40% active | 2.5 | 10 | pH = 11.28 |
| C | | | | |
| D | 50% Sodium hydroxide | | | |
| Total | | 100 | 400 | |

### Formula #23B (R1)—3.89% AMCOL GP/AMCOL FLT Based

| Phase | Ingredient | Weight, % | Total amount, gm | pH @25° C. |
|---|---|---|---|---|
| A | Deionized water | To 100% | 0 | |
| A | Aluminosilicate pre-gel (6% AMCOL | 64.75 | 259 | 3.89% (w/w) solids |
| | GP: 6% AMCOL FLT = 2.5) | | | |
| B | Ammonyx LO (30% active) | 3.33 | 13.34 | |
| | Chemical name: lauramine oxide | | | |
| B | Sodium xylene sulfonate (40% active) | 12.5 | 50 | |
| B | TEA | 5 | 20 | |
| B | Dowanol DPnB | 5 | 20 | |
| | Dowanol EpH | 5 | 20 | |
| C | Sodium silicate, ~40% active | 2.5 | 10 | |
| C | | | | |
| D | 50% Sodium hydroxide | 1.92 | 7.66 | pH = 13.14 |
| Total | | 100 | 400 | |

“AMCOL GP” refers to AMCOL Grey Prassa clay (R07-1287Prassa Clay) “AMCOL FLT” refers to attapulgite from Active Minerals, “XP” refers to extending polymer Hychem AF 251 added on clay.

### Rheology Profiles of High pH Cleaner Formulations

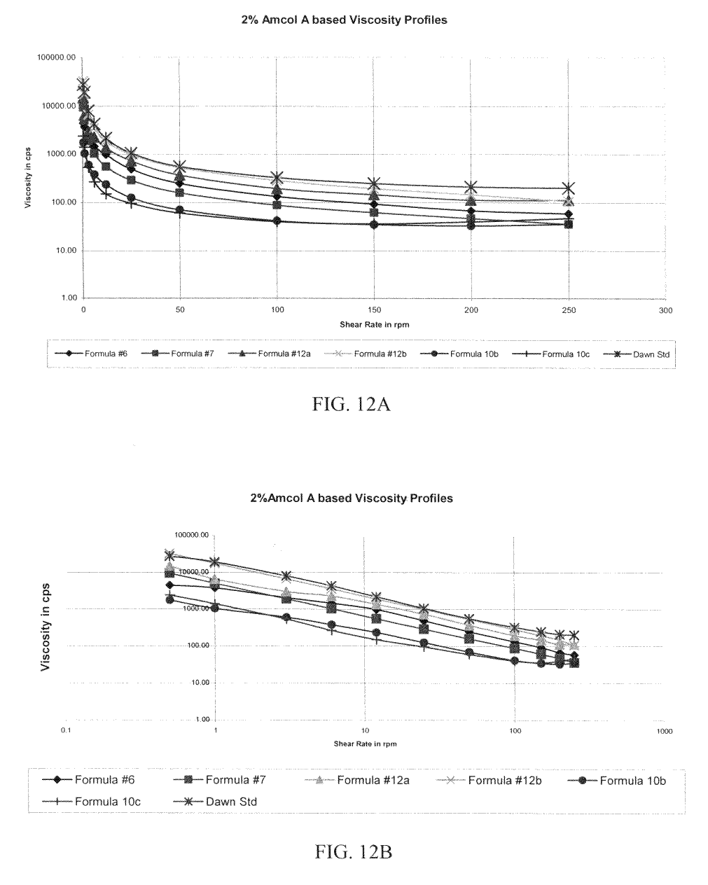

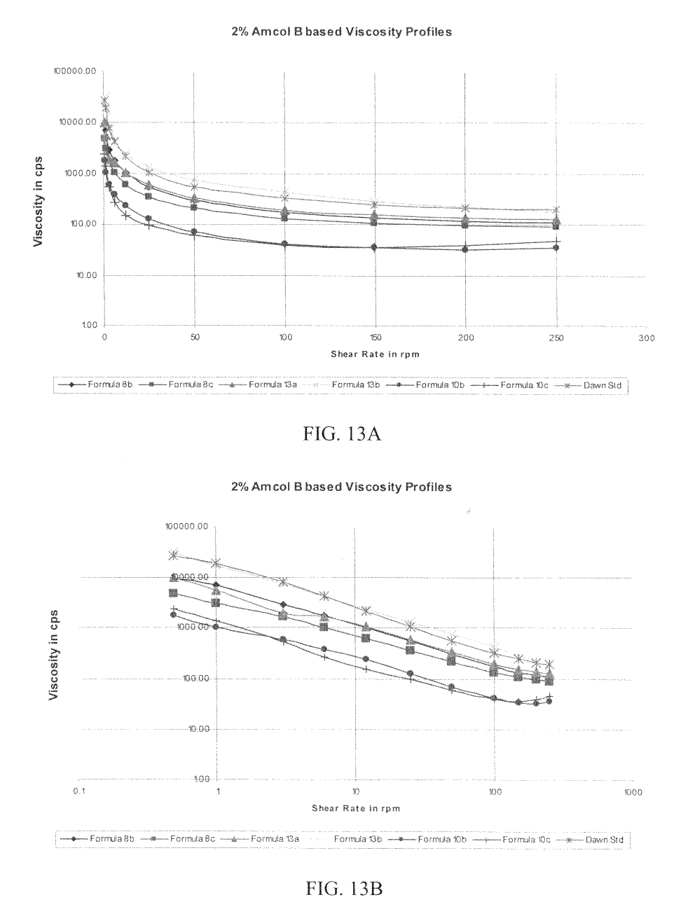

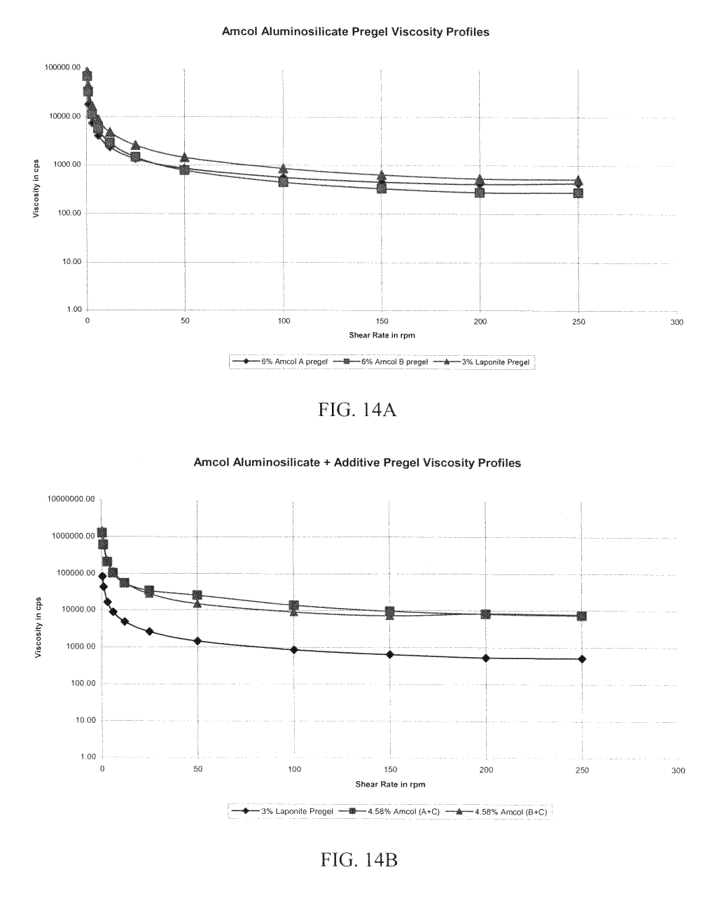

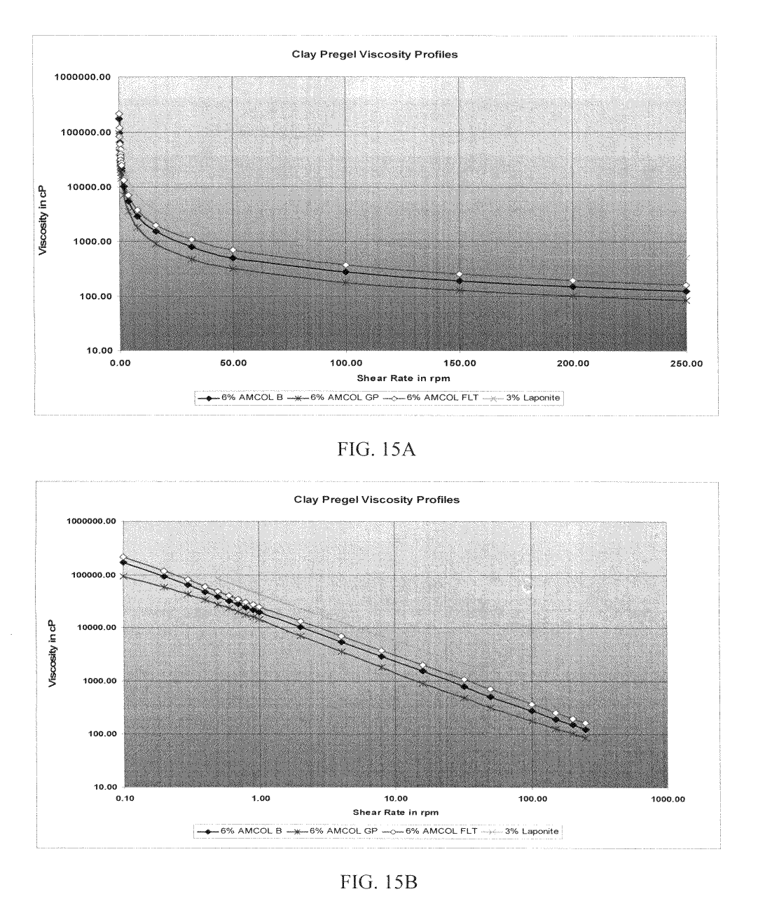

Prepared formulations were equilibrated at 25° C. for 30 minutes prior to conducting rheology measurements at varying shear rates with a Brookfield rheometer (FIGS. 12-14). The concentrations of aluminosilicates [AMCOL A, AMCOL B, AMCOL (A+C), AMCOL (B+C)] used in these formulations are at 2% (w/w) level. The plots have been illustrated in both semi-log and log-log format. The 2% (w/w) laponite based formulations 10B and 10C do not contain any other polymers. The rheology profiles of AMCOL rheology modifiers [AMCOL A, AMCOL B, AMCOL (A+C), AMCOL (B+C)] compared to laponite are shown in FIGS. 15a and 15b respectively.

AMCOL A and AMCOL B based formulations display similar viscosity profiles, and have much higher viscosity then 2% (w/w) laponite based formulations. AMCOL prototypes 12B and 13B match the viscosity profiles of the commercial control very closely. These formulations comprise AMCOL (A+C) and AMCOL (B+C) modifiers, NaOH, and no silicate, and have a pH>12.8. Although the AMCOL compositions 12B and 13B display lower viscosity, they provide excellent drip resistance. The viscosities of these pre-gels and formulations have been obtained at different shear rates starting from 250 rpm and going down to 0.5 rpm. The viscosity profiles for formulations are depicted in FIGS. 12, 13 and 14. The viscosity profiles for the pre-gels are shown in FIG. 15.

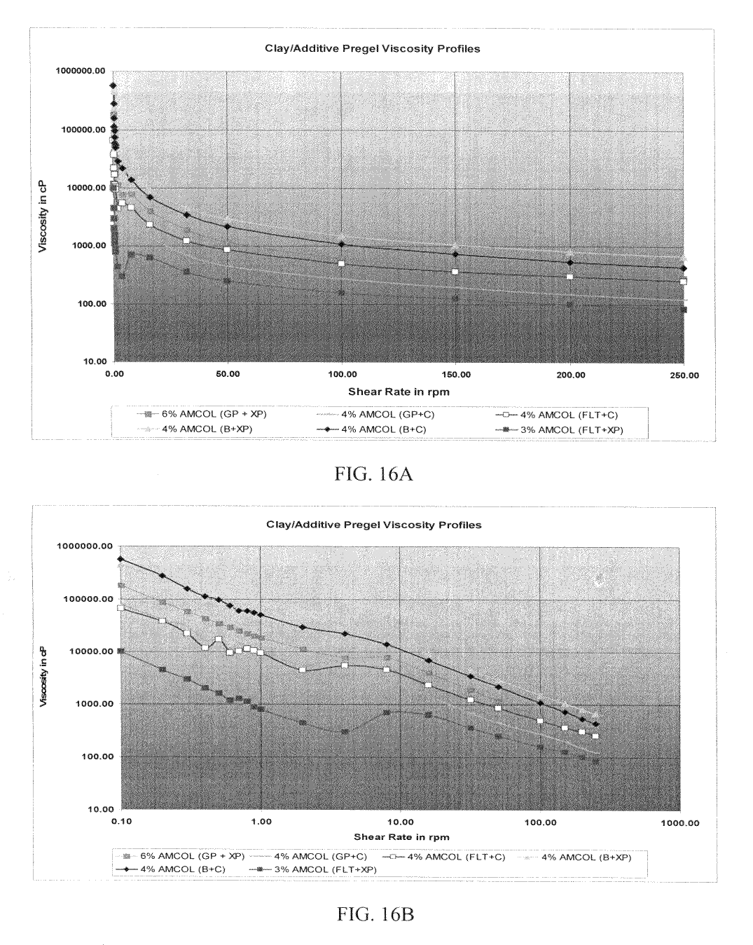

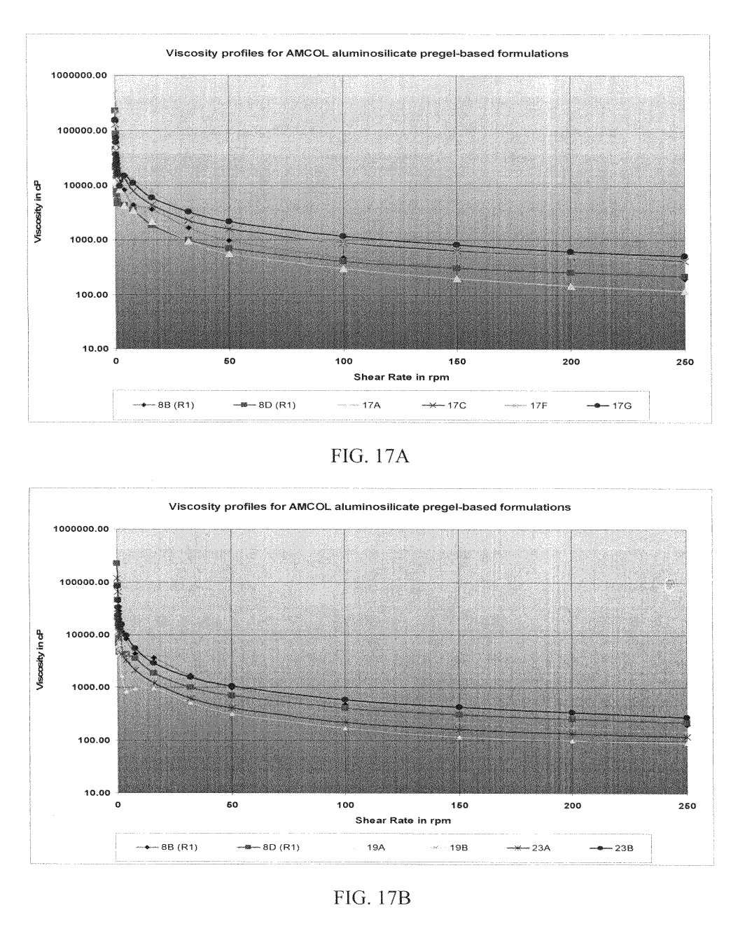

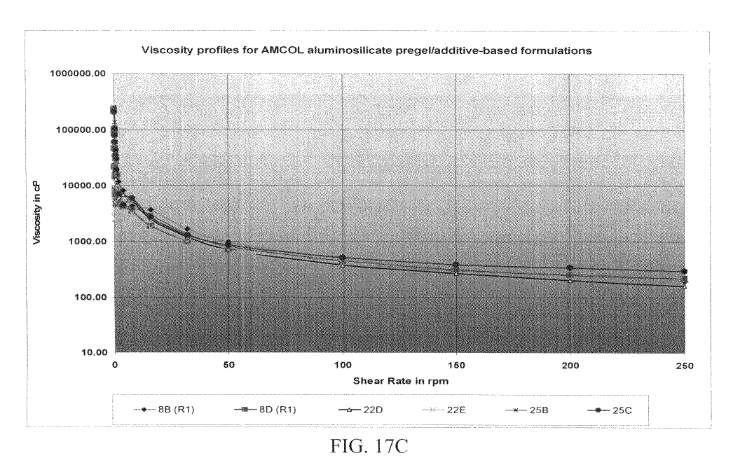

The viscosity profiles for the second set of pre-gels with additional aluminosilicates and additives are shown in FIGS. 16 and 17. These viscosities have been obtained at different shear rates using a slightly different program, starting from 0.1 rpm and going to 250 rpm. Because of the slightly different program used, the initial low shear viscosities are somewhat higher in this set of data due to gel formation. The low shear and high shear viscosities of these pre-gels, along with their shear thinning nature are listed in Table 6. The additive C helped in boosting the viscosity of the highly flocculating clays such as AMCOL A and AMCOL B when used at the same 0.58% (w/w) level for every 4% (w/w) of clay solids, but reduced the low shear viscosities of AMCOL GP and AMCOL FLT considerably. The extended polymer used in this study helped in increasing the viscosities of both AMCOL B and AMCOL GP at all shear rates, compared to the pre-gels without additives. Addition of AMCOL B to AMCOL GP helped in boosting the viscosity of the former pre-gel.

TABLE 6

| | | | | Degree of shear | |
|---|---|---|---|---|---|
| | Viscosity at | Viscosity at | Viscosity at | thinning = Visc at | |
| Sample | 0.5 rpm | 0.1 rpm | 200 rpm | 0.5/Visc. at 200 | pH |
| 6% AMCOL B | 75600.00 | 342000.00 | 257.60 | 293.48 | 9.712 |
| 6% AMCOL B with TiO2 | 70000.00 | 146000.00 | 258.40 | 270.90 | 8.738 |
| 4% AMCOL (B + C) | 98200.00 | 572000.00 | 550.00 | 178.55 | 11.724 |
| 4% AMCOL (B + XP) | 94400.00 | 454000.00 | 688.80 | 137.05 | 9.383 |
| 6% AMCOL GP | 28000.00 | 95000.00 | 103.00 | 271.84 | 10.072 |
| 6% AMCOL GP with TiO2 | 24600.00 | 122000.00 | 88.40 | 278.28 | 9.712 |
| 6% AMCOL GP + AMCOL B (1:1) with | 37200.00 | 174000.00 | 148.80 | 250.00 | 9.117 |
| TiO2 | | | | | |
| 6% AMCOL (GP + XP) | 34000.00 | 186000.00 | 293.60 | 115.80 | 9.810 |
| 4% AMCOL (GP + C) | 17600.00 | 37000.00 | 123.20 | 142.86 | 12.794 |
| 6% AMCOL FLT | 49200.00 | 106000.00 | 164.00 | 300.00 | 10.304 |
| 4% AMCOL (FLT + C) | 16800.00 | 66000.00 | 260.00 | 64.62 | 11.913 |
| 3% AMCOL(FLT + XP) | 1600.00 | 10000.00 | 101.00 | 15.84 | 10.099 |

The effect of additives C and extending polymers on pre-gels AMCOL GP and AMCOL FLT can be noted from the log-log curve 16b. In this figure, two distinct slopes are observed for these pre-gels with additives, the high shear region more characteristic of pure clay pre-gels with a single slope (as shown in FIG. 16a) and the low shear region may be due to break down of network or flocs formed between additives and clay particles, primarily due to the additive C or the extended polymer. This change in slope due to extending polymer is most pronounced for FLT, followed by GP, followed by B. From these data, it may also be concluded that the extending polymer is highly adsorbed on AMCOL B or interacting most with AMCOL B, compared to AMCOL FLT or AMCOL GP. This is probably related to the surface charge, charge density and distribution and other surface characteristics of the different clay particles. Therefore, the extending polymer is most effective in building the viscosity of pre-gel B compared to the others. The effect of additive C on the clay pre-gel viscosities follows the same order, although the change in slope is not so dramatic with this additive compared to that with the extending polymer. Also, the pH of AMCOL (FLT+C) and AMCOL (GP+C) pre-gels are much higher compared to AMCOL (B+C) as noted from Table 6, indicating much reduced interaction of additive C with the pre-gels GP and FLT. The additive C does not form an efficient flocculated structure with FLT and GP, compared to B. As a result formulations prepared with AMCOL (FLT+C) and AMCOL (GP+C) pre-gels did not meet the viscosity and stability specifications, compared to those made with pre-gel AMCOL (B+C).

The effect of the additive C on the clay pre-gel viscosities is listed for some AMCOL aluminosilicates below in Table 8. The additive C makes pre-gels AMCOL A and AMCOL L more shear thinning as observed from the degree of shear thinning, when compared to formulations without the additive. All other pre-gels become less shear thinning with the additive C. The deleterious effect of additive C is most pronounced on pre-gel AMCOL FLT. Also, the formulations prepared with AMCOL (FLT+C) and AMCOL (GP+C) performed poorly in terms of viscosity and stability.

TABLE 8

| | | | Degree of | |
|---|---|---|---|---|
| | | | shear | |
| | | | thinning = | |
| | | | Visc at | CEC |
| | Viscosity at | Viscosity | 0.5/Visc. | of clay, |
| Sample | 0.5 rpm | at 200 rpm | at 200 | meq/g |
| 6% AMCOL B | 75600.00 | 257.60 | 293.48 | ~124 |
| (second data set) | | | | |
| 4% AMCOL (B + C) | 98200.00 | 550.00 | 178.55 | |
| 6% AMCOL GP | 28000.00 | 103.00 | 271.84 | ~96 |
| 4% AMCOL (GP + C) | 17600.00 | 123.20 | 142.86 | |
| 6% AMCOL FLT | 49200.00 | 164.00 | 300.00 | ~25 |
| 4% AMCOL (FLT + C) | 16800.00 | 260.00 | 64.62 | |
| 6% AMCOL A | 37600 | 411 | 91.48 | ~106 |
| 4% AMCOL (A + C) | 1256000.00 | 8040.00 | 156.22 | |
| 6% AMCOL L | 14000.00 | 241.00 | 58.09 | ~90 |
| 4% AMCOL (L + V) | 312000.00 | 1680.00 | 185.71 | |
| 6% AMCOL V | 12000.00 | 105.00 | 114.29 | ~132 |
| 4% AMCOL (V + C) | 136000.00 | 1620.00 | 83.95 | |
| 6% AMCOL B | 66800.00 | 276.00 | 242.03 | ~124 |
| (previous data set) | | | | |
| 4% AMCOL (B + C) | 1456000.00 | 8240.00 | 176.70 | |

AMCOL L and AMCOL V correspond to highly purified AMCOL PGL IX and PGV clays respectively, not used in this study.

### Accelerated Stability Study of Cleaning Formulations

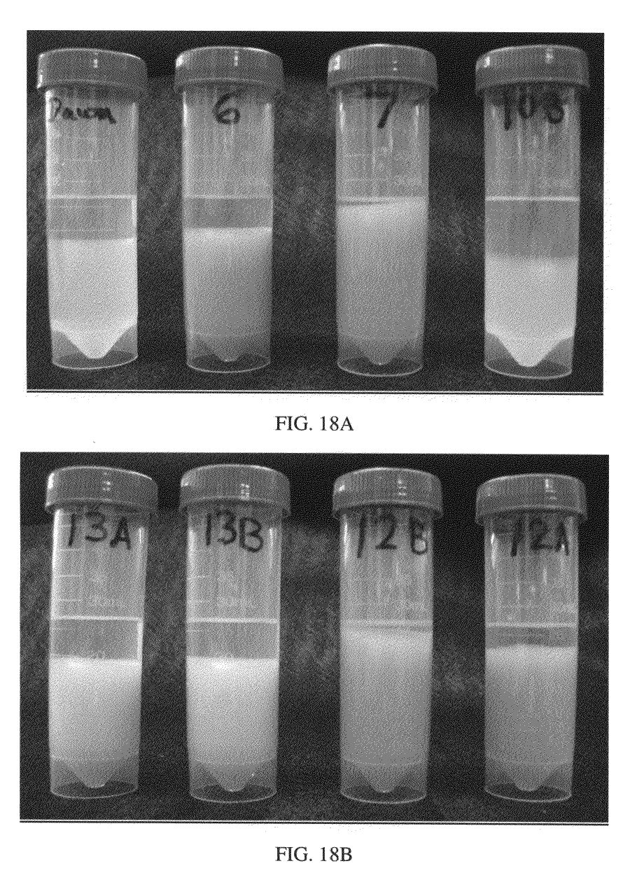

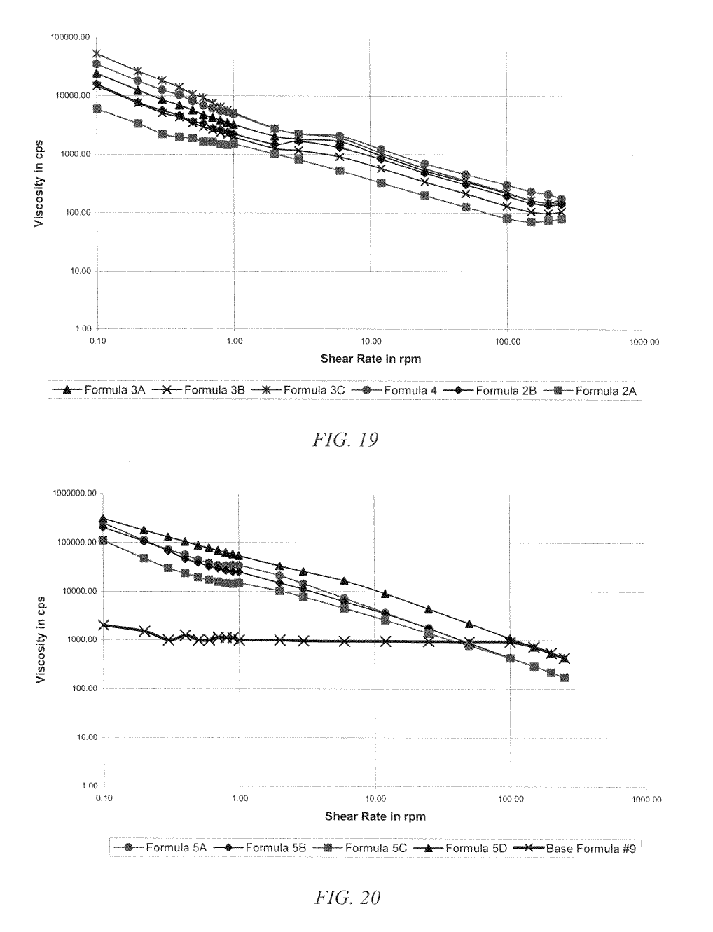

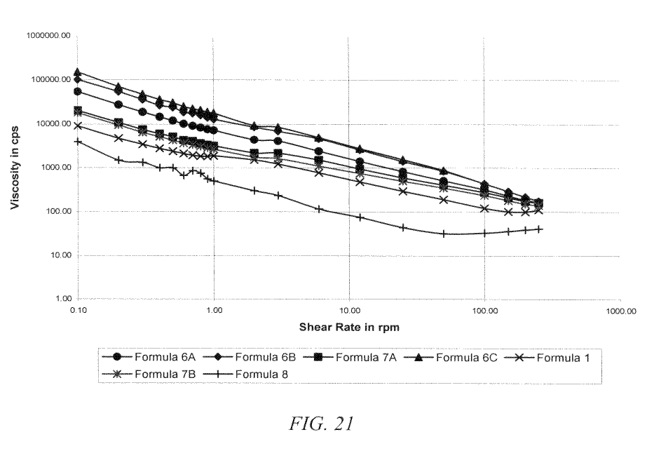

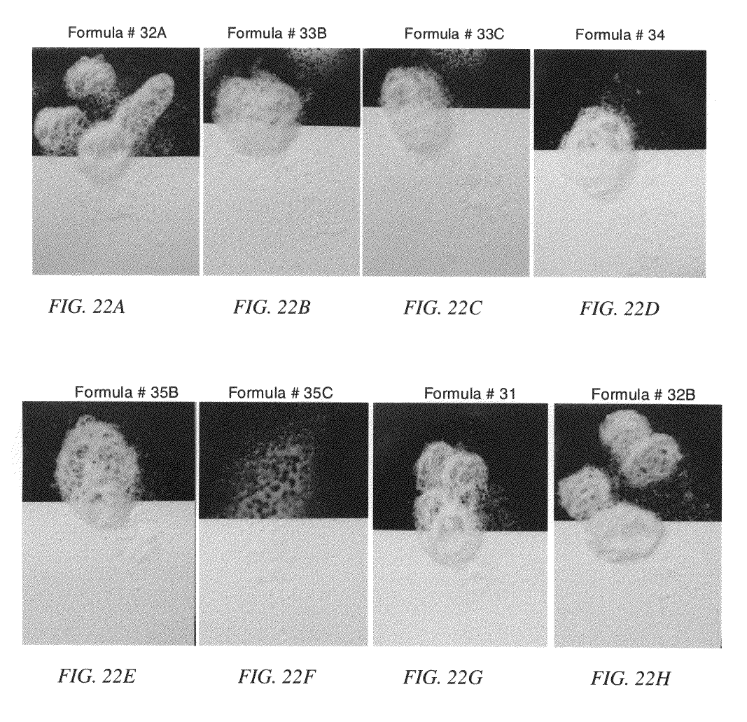

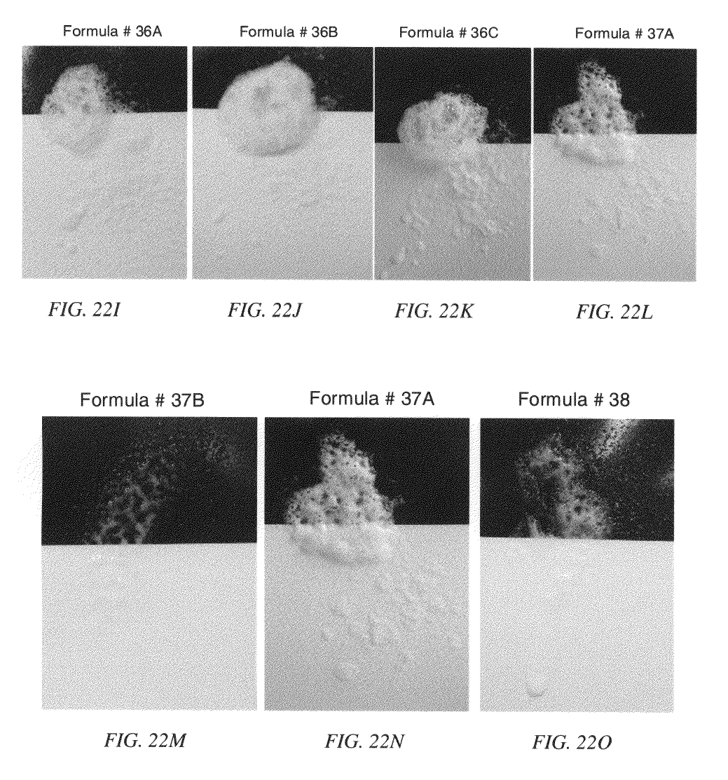

Accelerated stability studies of the formulations were conducted by warming the formulations in centrifuge tubes at 45° C. for approximately 2 hours. The samples were then centrifuged at 1000 rpm for 15 min, or 2000 rpm for 15 min, and the volume of the water layer in each tube was observed. The accelerated stability study showed that prototypes 7 and 12B performed best in terms of water layer separation (FIG. 18). Prototypes 6, 12A, 13A, 13B, 8B, 8C performed comparable to the Dawn Power Dissolver in terms of water layer separation (FIG. 18).

The results from the accelerated study for the first set of formulations, as measured visually, are tabulated in Table 9. The measurement error in the readings is estimated to be at most +/−1 cc.

TABLE 9

| | | % water | | % water |
|---|---|---|---|---|
| Formula # | 1000 rpm for 15 min | separated | 1000 rpm for 15 min | separated |
| 6 | 20 cc gel + 6 cc water | 23.07 | 19 CC gel + 7.5 cc water | 28.30 |
| 7 | 25 cc gel + .5 cc water | 1.97 | 24 CC gel + 1.5 cc water | 5.88 |
| 8B | 17 cc gel + 10 cc water | 37.04 | 14.5 CC gel + 12 cc water | 45.28 |
| 8C | 15 cc gel + 11 cc water | 42.31 | 12 CC gel + 15 cc water | 55.55 |
| 12A | 22 cc gel + 5 cc water | 18.51 | 20 CC gel + 7 cc water | 25.93 |
| 12B | 25 cc gel + .5 cc water | 1.97 | 24 CC gel + 2.5 cc water | 9.4 |
| 13A | 20 cc gel + 7 cc water | 25.93 | 17 CC gel + 10 cc water | 37.04 |
| 13B | 19 cc gel + 8.5 cc water | 30.91 | 16 CC gel + 10.5 cc water | 39.62 |
| 10B | 15 cc gel + 12 cc water | 44.44 | 14 CC gel + 13 cc water | 48.15 |
| Dawn | 20 cc gel + 7.5 cc water | 27.27 | 17 CC gel + 10 cc water | 37.04 |

The results from the accelerated study for the second set of formulations, as measured visually, are tabulated in Table 10. The measurement error in the readings is estimated to be at most +/−1 cc. From the stability studies, samples 16A, 16B, 18A, 18B, 19A, 20A, 20B, 21B, 21C, 22A, 22B, 25A can be considered to be unstable compared to the Dawn Power Dissolver control formulation. It has been also observed among formulations in the same series that increased solids content helped in improving the stability, and non-dripping function of the formulations. These considerations have been taken into account in identifying the ideal composition of several formulations in Table 5.

Highly flocculating clays do not perform as well as the slightly less flocculating ones in terms of stability. More flocculated systems can generate the low or high shear viscosity, but may not have the high temperature stability. Therefore, the size, surface charge, distribution of charge, charge density of clay particles and the size and type of flocs play an important role in determining which type of clay will be useful in such formulations.

TABLE 10

| | | after heating at | | after heating at | |
|---|---|---|---|---|---|
| | | 45° C., 1000 rpm, | | 45° C., 2000 rpm, | |
| | | 15 min, cc water | % | 15 min, cc water | % |
| Sample | stability at RT | out of 43 cc total | water | out of 43 cc total | water |
| 8BR1 AMCOL B w/ TiO2, | no separation | 5 | 11.628 | 11 | 25.581 |
| 2.18% TiO2 on clay | | | | | |
| 8CR1 AMCOL B w/ TiO2, | no separation | 4 | 9.3023 | 13 | 30.233 |
| 2.18% TiO2 on clay | | | | | |
| 8D R1 AMCOL B w/ TiO2, | no separation | 2 | 4.6512 | 7 | 16.279 |
| 2.18% TiO2 on clay | | | | | |
| 16A AMCOL GP | 9 mm water | | | | |
| 16B AMCOL GP | 3 mm water | 18 | 41.86 | 28 | 65.116 |
| 16C AMCOL GPwith TiO2, | 20 mm water | | | | |
| 2.18% TiO2 on clay | | | | | |
| 17A AMCOL GP + AMCOL B, | no separation | 10 | 23.256 | 18 | 41.86 |
| 2.18% T O2 on clay | | | | | |
| 17B AMCOL GP + AMCOL B, | no separation | 5 | 11.628 | 15 | 34.884 |
| 2.18% T O2 on clay | | | | | |
| 17C AMCOL GP + AMCOL B, | no separation | 4 | 9.3023 | 8 | 18.605 |
| 2.18% T O2 on clay | | | | | |
| 17D (R1) AMCOL GPTiO2 + | | 3 | 6.9767 | 8 | 18.605 |
| AMCOL B TiO2, 2.18% TiO2 | | | | | |
| on clay | | | | | |
| 17E AMCOL GP/TiO2 + | no separation | 2 | 4.6512 | 7 | 16.279 |
| AMCOL B/TiO2, 2.18% TiO2 | | | | | |
| on clay | | | | | |
| 17 F AMCOL GP + AMCOL B | 0.5 mm water | 3.5 | 8.1395 | 9 | 20.93 |
| 17 G AMCOL GP + AMCOL B | no separation | 4 | 9.3023 | 8 | 18.605 |
| 17 M AMCOL GP/TiO2 + | no separation | | 0 | | 0 |
| AMCOL B/TiO2 | | | | | |
| 18A AMCOL (GP + C) | 9 mm water | | | | |
| 18B AMCOL (GP + C) | 9 mm water | | | | |
| 19A AMCOL FLT | 1.5 mm water | 13 | 30.233 | 20 | 46.512 |
| 19B AMCOL FLT | no separation | 3.5 | 8.1395 | 18 | 41.86 |
| 19C AMCOL FLT + AMCOL B | no separation | 4 | 9.3023 | 8 | 18.605 |
| 19 D AMCOL FLT + AMCOL B | no separation | 3.5 | 8.1395 | 8 | 18.605 |
| 19E AMCOL FLT | 0.5 mm water | 15 | 34.884 | 15 | 34.884 |
| 19 F AMCOL FLT | no separation | 8 | 18.605 | 15 | 34.884 |
| 20A AMCOL (FLT + C) | 3 mm water | 22 | 51.163 | 28 | 65.116 |
| 20B AMCOL (FLT + C) | 2 mm water | 23 | 53.488 | 30 | 69.767 |
| 21A (3% AMCOL (B + XP)), | 16 mm water | | | | |
| 0.25% exp on clay | | | | | |
| 21B (3% AMCOL (B + XP)), | 18 mm water | | | | |
| 0.25% exp on clay | | | | | |
| 21C (3% AMCOL (B + XP)), | 10 mm water | | | | |
| 0.25% exp on clay | | | | | |
| 22A (6% AMCOL (GP + XP)), | 18 mm water | | | | |
| 0.15% XP on clay | separation | | | | |
| 22B (6% AMCOL (GP + XP)), | 0.5 mm water | 20 | 46.512 | 20 | 46.512 |
| 0.15% XP on clay | | | | | |
| 22C (6% AMCOL (GP + XP)), | no separation | 5 | 11.628 | 15 | 34.884 |
| 0.15% XP on clay | | | | | |
| 22D (6% AMCOL (GP + XP)) + | no separation | 10 | 23.256 | 17 | 39.535 |
| (4% AMCOL (B + XP)), 0.15% | | | | | |
| XP on AMCOL GP& 0.25% XP | | | | | |
| on AMCOL B | | | | | |
| 22E (6% AMCOL (GP + XP)) + | 0.5 mm water | 2 | 4.6512 | 11 | 25.581 |
| (4% AMCOL (B + XP)), 0.15% | | | | | |
| XP on AMCOL GP& 0.25% XP | | | | | |
| on AMCOL B | | | | | |
| 23A AMCOL GP + AMCOL FLT | 0.5 mm water | 13 | 30.233 | 18 | 41.86 |
| 23B AMCOL GP + AMCOL FLT | no separation | 4.5 | 10.465 | 15 | 34.884 |
| 25A AMCOL(B + C)/TiO2, 5% | no separation | 13 | 30.233 | 20 | 46.512 |
| TiO2 on clay | | | | | |
| 25B AMCOL(B + C)/TiO2, 5% | no separation | 8 | 18.605 | 15 | 34.884 |
| TiO2 on clay | | | | | |
| 25C AMCOL(B + C)/TiO2, 5% | no separation | 10 | 23.256 | 17 | 39.535 |
| TiO2 on clay | | | | | |
| Dawn Power dissolver | no separation | 20 cc gel + 7.5 cc | 27.27 | 17 cc gel + 10 cc | 37.04 |
| | | water | | water | |

### Cleaning Compositions with Bleach

The high pH cleaners with bleach may contain anionic surfactants, amine oxide type of salt tolerant yet foaming surfactants, hydrotopes, glycol ethers, sodium hydroxide, silicates, bleach, and rheology modifiers. Examples of formulations of high pH cleaners with bleach that provide good clinging foam on a vertical substrate, are given below. Formula #31 represents formulas made with ˜1.56% (w/w) AMCOL B, AMCOL A, and AMCOL V respectively. The aluminosilicate solids content can vary in the range 1-3.5% (w/w) of the formulation for a viscous formulation, creamy and clinging foam.

Formula #31—1.56% (w/w) AMCOL B Solids

| Phase | Ingredient | Raw Active % | Active, % | Weight, % | |
|---|---|---|---|---|---|
| 1 | Deionized water | | | qs | |
| 1 | Sodium Xylene sulfonate | 40 | 5-7 | 12.5-17.5 | |
| 1 | Ammonyx Lo (30% active, | 30.00 | 1-3 | 3.33-10 | |
| | 70% water) | | | | |
| | Chemical name: lauramine | | | | |
| | oxide | | | | |
| 2 | SLS/SLES | 100.00 | 0-5 | 0-5 | |
| 3 | Dowanol DPnB | 100.00 | 0-5 | 0-5 | |
| 3 | Dowanol Eph | 100.00 | 0-5 | 0-5 | |
| 4 | NaOCl, 12% | 12.00 | 1-5 | 8.33-33.33 | |
| 4 | 50% Sodium hydroxide | 50.00 | 2 | 4.00 | |
| 5 | Aluminosilicate pregel | 6.00 | 1.56 | 26.00 | pH = 13-13.5 |
| | (6% AMCOL B pregel) | | | | |
| Total | | | | 100.00 | slightly creamy |
| | | | | | foam |

The above formulation can be processed in two ways to ensure appropriate dispersion of the aluminosilicate pre-gel in the formulation, development of viscosity, and less air entrapment:
(1) If a solid surfactant (phase 2) is used then all the ingredients in phase 1 are mixed with an overhead mixer at 200-300 rpm (low enough not to foam), and then SLS is dissolved in phase 1. The glycol ethers in phase 3 are then added and mixed. The phase 4 ingredients are then added and mixed. The aluminosilicae pre-gel is then added and finally mixed at 300-500 rpm with a rotor/stator mixer such as Silverson L4R with a square mesh screen.
(2) The other method involves addition of excess water to the aluminosilicate pre-gel and mixing it at with a Silverson L4R type rotor/stator mixer around 1000 rpm to make a homogenous dispersion. Then the other phases are added in the same order as above; however the mixing is done at a much lower speed 300-500 rpm.

Formula #32 is a representative formula for using AMCOL (A+C) or AMCOL (B+C) or AMCOL (V+C) pre-gels. The aluminosilicate solids content can vary from 1.5-2.5% (w/w) in the formulations and provide high viscosity to formulations and good non-dripping foams on vertical substrates.

Formula #32—1.5% (w/w) AMCOL (B+C) Solids

| Phase | Ingredient | Raw Active % | Active, % | Weight, % | |
|---|---|---|---|---|---|
| 1 | Deionized water | | | qs | |
| 2 | Sodium Xylene | 40 | 5-7 | 12.5-17.5 | |
| | sulfonate | | | | |
| 3 | Ammonyx Lo (30% | 30 | 1-3 | 10 | |
| | active, 70% water) | | | | |
| | Chemical name: | | | | |
| | lauramine oxide | | | | |
| 4 | SLS/SLES | 100 | 0-5 | 5 | |
| 5 | Dowanol DPnB | 100 | 0-5 | 0-5 | |
| 5 | Dowanol Eph | 100 | 0-5 | 0-5 | |
| 5 | NaOCl, 12% | 12 | 2.6 | 21.67 | |
| 6 | 50% Sodium hydroxide | 50 | 2 | 4 | |
| 7 | Aluminosilicate pregel, | 4.58 | 1.5 | 32.75 | 13.12 @ 21.8 C. |
| | AMCOL (B + C) | | | | |
| Total | | | | 100 | very creamy foam |

When 2% (w/w) of the aluminosilicate solids containing the additive C are used together with higher levels of anionic surfactants, tremendous amount of air is entrapped by the highly viscous formulation, which in turn leads to instability of the formulation. The aluminosilicate gel mass is lifted by the large number of air bubbles, leaving a clear solution at the bottom. This can be prevented by using amine oxide based surfactants alone or very low amounts of anionic surfactants together with amine oxide surfactants. This is especially true for pre-gels containing the additive C. Formulas #33 and #34 are representative formulas for using AMCOL (A+C) or AMCOL (B+C) or AMCOL (V+C) pre-gels, when using higher amounts of these pre-gels. This formula also applies to formulations containing 1-3% (w/w) of AMCOL A, AMCOL B, and AMCOL V aluminosilicate pre-gels.

Formula #33—2% (w/w) AMCOL (B+C) Solids—Less Foaming and More Stable

| Phase | Ingredient | Raw Active % | Active, % | Weight, % | |
|---|---|---|---|---|---|
| 1 | Deionized water | | | qs | |
| 2 | Sodium Xylene sulfonate | 40 | 5-7 | 12.5-17.5 | |
| 3 | Ammonyx Lo (30% | 30.00 | 0.5-3 | 1.67-10 | |
| | active, 70% water) | | | | |
| | Chemical name: | | | | |
| | lauramine oxide | | | | |
| 4 | Dowanol DPnB | 100 | 0-5 | 0-5 | |
| 4 | Dowanol Eph | 100 | 0-5 | 0-5 | |
| 5 | NaOCl, 13.5% | 13.50 | 2.60 | 19.26 | |
| 6 | 50% Sodium hydroxide | 50.00 | 2.00 | 4.00 | |
| 7 | SLS, Stepanol WA Extra | 29.00 | 0.5-2 | 1.72-6.89 | |
| 7 | Aluminosilicate pregel, | 4.58 | 2.00 | 43.67 | pH = 13.18 @ 20 C. |
| | AMCOL (B + C) | | | | |
| Total | | | | 100.00 | very creamy foam |

When SLS is replaced by laureth sulfate, such as Steol CS 270 (70% active), the stability of the above formulation is further improved.

Formula #3—2% (w/w) AMCOL (B+C) Solids

| Phase | Ingredient | Raw Active % | Active, % | Weight, % | |
|---|---|---|---|---|---|
| 1 | Deionized water | | | qs | |
| 2 | Sodium Xylene sulfonate | 40 | 5-7 | 12.5-17.5 | |
| | 70% water) | | | | |
| 3 | Chemical name: | 30.00 | 0.5-3 | 1.67-10 | |
| | lauramine oxide | | | | |
| 4 | Dowanol DPnB | 100 | 0-5 | 0-5 | |
| 4 | Dowanol Eph | 100 | 0-5 | 0-5 | |
| 5 | NaOCl, 13.5% | 13.50 | 2.60 | 19.26 | |
| 6 | 50% Sodium hydroxide | 50.00 | 2.00 | 4.00 | |
| 7 | SLS, Stepanol WA Extra | 29.00 | 0.5-2 | 1.72-6.89 | |
| 7 | Aluminosilicate pregel, | 4.58 | 2.00 | 43.67 | pH = 13.18 @ 20 C. |
| | AMCOL (B + C) | | | | |

When the anionic surfactant level is reduced or eliminated (as in Formulas 33, 34) the stability of the formulations is improved without hampering the foam quality and the non-dripping nature of the foam. In a modified version of Formula #35 below, it has been found that inclusion of 5% (w/w) SLS and 2.5% (w/w) hydrotope (sodium xylene sulfonate), and 3% (w/w) amine oxide results in a highly viscous non-sprayable formulation. When anionic surfactant is eliminated form the formulation as in Formula #35, the same formulation can be sprayed in the form of a creamy non-dripping foam at a comparable level of amine oxide and with or without hydrotope. Also, the Formula #35 becomes sprayable when the amount of hydrotope is increased from 2.5 to above 5% (w/w) in formulation. There is a minimum ratio of ˜1:1 for hydrotope: anionic surfactant for sprayability of the foam. Excess hydrotope only helps in solubilization of the surfactants and sprayability of the formulation.

Formula #35—2% (w/w) AMCOL B Solids

| Phase | Ingredient | Raw Active % | Active, % | Weight, % | |
|---|---|---|---|---|---|
| 1 | Deionized water | | | qs | |
| 2 | Sodium Xylene sulfonate | 40 | 0-2.5 | 0-6.25 | |
| 3 | Ammonyx Lo (30% | 30 | 1-3 | 3.33-10 | |
| | active, 70% water) | | | | |
| | Chemical name: lauramine | | | | |
| | oxide | | | | |
| 4 | NaOCl, 13.5% | 12 | 2.93 | 21.67 | |
| 5 | 50% Sodium hydroxide | 50 | 2 | 4 | |
| 1 | Aluminosilicate (6% | 6 | 2 | 33.33 | pH = 13.17 @ 23.1 C. |
| | AMCOL B pregel) | | | | |
| Total | | | | 100 | |

AMCOL aluminosilicate pre-gels based on AMCOL A, AMCOL B, AMCOL V alone or in combination with the additive C can act as thickeners for bleach formulations up to 10% (w/w) of bleach. A representative formulation containing high concentration of bleach, amine oxide surfactant and NaOH is given by Formula #36, which is also sprayable and provide creamy non-dripping foam on a vertical substrate. A thickened formulation without any surfactant or NaOH can be sprayed on to a vertical substrate as a clinging but slightly foaming spray as in Formula # 37 below. When formula 37 is made without any hydrotope, the formula can be still sprayed on to a substrate as a non-dripping but totally non-foaming spray.

Formula #36—2% (w/w) AMCOL B Solids

| Phase | Ingredient | Raw Active % | Active, % | Weight, % | |
|---|---|---|---|---|---|
| 1 | Stepanol WA Extra, 29% | 29 | 0-1.3 | 0-4.5 | |
| 2 | Deionized water | | | qs | |
| 3 | Sodium Xylene sulfonate | 40 | 5.4 | 13.5 | |
| 4 | Ammonyx Lo (30% active, | 30 | 1-3 | 3.33-10 | |
| | 70% water) | | | | |
| | Chemical name: lauramine | | | | |
| | oxide | | | | |
| 5 | NaOCl, 13.5% | 13.5 | 2-6 | 14.8-44.44 | |
| 6 | 50% Sodium hydroxide | 50 | 2 | 4 | |
| 7 | Aluminosilicatel (6% | 6 | 2 | 33.33 | pH = 13.16 @ 23.8 C. |
| | AMCOL B pregel) | | | | |
| Total | | | | 100 | |

Formula #37—2% (w/w) AMCOL B Solids

| | | Raw | Active, | | |
|---|---|---|---|---|---|
| Phase | Ingredient | Active % | % | Weight, % | |
| 1 | Deionized water | | | qs | |
| 1 | Sodium Xylene | 40 | 0-7 | 0-17.5 | |
| | sulfonate | | | | |
| 1 | NaOCl, 13.5% | 13.5 | 5-8 | 37-59.26 | |
| 2 | Aluminosilicatel (6% | 6 | 2 | 33.33 | |
| | AMCOL B pregel) | | | | |
| Total | | | | 100 | pH = 12 |

When AMCOL aluminosilicates are replaced by laponite in Formula #38 (otherwise similar to Formula #37), a relatively thin and translucent formulation is obtained, which creates a dripping foam when sprayed on to a vertical substrate.

Formula #38—1.9% (w/w) Laponite

| | | Raw | | | |
|---|---|---|---|---|---|
| Phase | Ingredient | Active % | Active, % | Weight, % | |
| 1 | Deionized water | | | qs | |
| 1 | Sodium Xylene | 40.00 | 0-7 | 0-17.5 | |
| | sulfonate | | | | |
| 1 | NaOCl, 13.5% | 13.50 | 5-8 | 37-59.26 | |
| 2 | Clay pre-gel | 4.00 | 1.5-2 | 1.5-2 | pH = 11.9 |
| | (4% Laponite | | | | |
| | pre-gel) | | | | |
| Total | | | | 100.00 | |

The base formulation with surfactants and without any AMCOL aluminosilicate based rheology modifier is shown in Formula #39. This formula is similar to Formula #35 and also could not be sprayed like Formula # 35D—both containing very low level of 2.5% (w/w) sodium xylene sulfonate as the hydrotope.

Formula-39—Surfactant Base without Aluminosilicates

| | | Raw | | | |
|---|---|---|---|---|---|
| | | Active | Active, | Weight, | |
| Phase | Ingredient | % | % | % | |
| 1 | Deionized water | | | qs | |
| 1 | Ammonyx Lo (30% | 30.00 | 3.00 | 10.00 | |
| | active, 70% water) | | | | |
| | Chemical name: | | | | |
| | lauramine oxide | | | | |
| 2 | SLS (sodium lauryl | 100.00 | 5.00 | 5.00 | |
| | sulfate) | | | | |
| 1 | Sodium Xylene sulfonate | 40.00 | 2.50 | 6.25 | |
| 3 | NaOCl, 12% | 12.00 | 2.60 | 21.67 | |
| 3 | 50% Sodium hydroxide | 50.00 | 2.00 | 4.00 | pH = 13.1 |
| Total | | | | 100 | |

### Summary of Viscosity and Foam Quality of High pH Bleach Formulations

| | | | % | | | % alumino | | Vis- | Vis- | Vis- | Degree of | |
|---|---|---|---|---|---|---|---|---|---|---|---|---|
| Formula | % | % | Amine | % Xylene | % | silicate | | cosity at | cosity at | cosity at | shear | |
| # | SLS | SLES | Oxide | sulfonate | NaOCl | solids | Pregel type | 0.5 rpm | 0.1 rpm | 200 rpm | thinning | Foam quality |
| 32A | 5 | 0 | 3 | 6.12 | 2.6 | 1.5 | AMCOL (B + C) | 1920 | 6000 | 74.8 | 25.67 | creamy, non-drip |
| 32B | 5 | | 3 | 6 | 2.6 | 2 | AMCOL (B + C) | 3680 | 16000 | 136.8 | 26.90 | creamy, non-drip |
| 33A | 1.3 | 0 | 3 | 5 | 2.6 | 2 | AMCOL (B + C) | 5760 | 24400 | 151.8 | 37.94 | creamy, non-drip |
| 33B | 1.3 | 0 | 0.6 | 5 | 2.6 | 2 | AMCOL (B + C) | 3520 | 14800 | 99.2 | 35.48 | creamy, non-drip |
| 33C | 0 | 1.3 | 3 | 5 | 2.6 | 2 | AMCOL (B + C) | 10720 | 52400 | 150.6 | 71.18 | creamy, non-drip |
| 34 | 0 | 0 | 3 | 5 | 2.6 | 2 | AMCOL (B + C) | 8400 | 35200 | 210.4 | 39.92 | creamy, non-drip |
| 35A | 0 | 0 | 3 | 2.5 | 2.93 | 2 | AMCOL B | 45040 | 254800 | 220 | 204.73 | creamy, non-drip |
| 35B | 0 | 0 | 1 | 2.5 | 2.93 | 2 | AMCOL B | 39440 | 204800 | 220 | 179.27 | creamy, non-drip |
| 35C | 0 | 0 | 1 | 0 | 2.93 | 2 | AMCOL B | 19760 | 110800 | 220 | 89.82 | no foam, non-drip |
| 35D | 5 | 0 | 3 | 2.5 | 2.6 | 2 | AMCOL B | 89400 | 312000 | 550 | 162.55 | did not spray |
| 31 | 5 | 0 | 3 | 5.4 | 2.6 | 1.56 | AMCOL B | 2400 | 9200 | 100.8 | 23.81 | creamy, non-drip |
| 36A | 1.3 | 0 | 3 | 5.4 | 3.6 | 2 | AMCOL B | 12080 | 54400 | 185.8 | 65.02 | creamy, non-drip |
| 36B | 1.3 | 0 | 3 | 5.4 | 4.6 | 2 | AMCOL B | 24000 | 102000 | 220 | 109.09 | very creamy, non drip |
| 36C | 0 | 0 | 2.3 | 5.4 | 5.6 | 2 | AMCOL B | 30480 | 153200 | 220 | 1.82 | creamy, non-drip |
| 37A | 0 | 0 | 0 | 5.4 | 5.6 | 2 | AMCOL B | 5200 | 20400 | 175.6 | 109.09 | less foam, non-drip |
| 37B | 0 | 0 | 0 | 0 | 5.6 | 2 | AMCOL B | 4320 | 18000 | 151.8 | 65.02 | no foam, non-drip |
| 38 | 0 | 0 | 0 | 5 | 5.4 | 1.9 | laponite | 1000 | 4000 | 39 | 138.55 | foamy, dripping |
| 39 | 5 | 0 | 3 | 2.5 | 5.6 | 2 | none | 1000 | 2000 | 550 | 29.61 | no foam, non-drip |

### Comparison of Base Clays

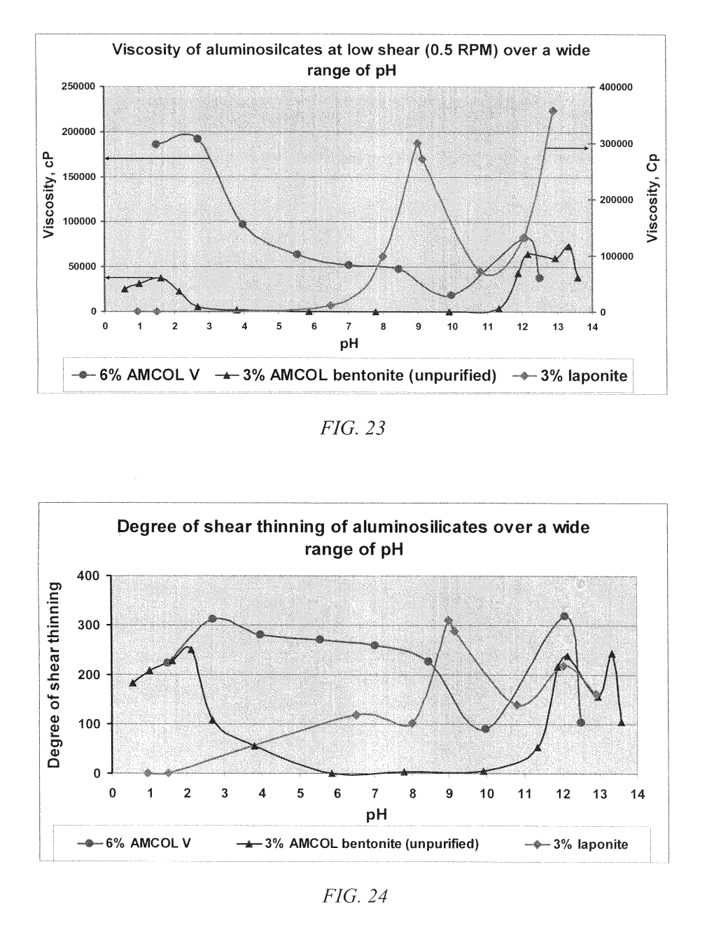

The effectiveness of AMCOL purified aluminosilicates is easily observed by comparing one such aluminosilicate, AMCOL V, with a regular unpurified AMCOL bentonite, and a synthetic hectorite such as laponite. Three base clays have been compared against each other: 3% AMCOL bentonite (unpurified), 6% AMCOL V (purified and ion-exchanged in Na-form), and 3% laponite. The aluminosilicate pre-gels were prepared in deionized water and were then adjusted to the desired pH with NaOH or HCl solution. Similarly, NaCl solution of a particular strength was added to increase the salt concentration on clay in another set of pre-gel formulations, maintained at the native pre-gel pH of ˜10. The concentration of solids in the adjusted final pH/salt containing pre-gel was corrected for any dilution due to the addition of base or acid or salt solution. The effects of pH and salt on each of these clays are demonstrated in the FIGS. 23-26. In FIG. 23, the left Y-axis represents the viscosity axis of the AMCOL bentonite (unpurified) and AMCOL V, while the right secondary Y-axis represents the viscosity axis for the laponite only. The AMCOL V or purified clay has a high low shear (0.5 rpm) viscosity over a wide range of pH compared to unpurified bentonite and the synthetic laponite. The synthetic laponite performs poorly at pHs lower than 7, while the regular bentonite exhibits some viscosity only at very low and very high pHs.

The degree of shear thinning as described by the ratio of viscosity at 0.5 rpm to viscosity at 200 rpm in this disclosure vs. pH for each of the clays is also shown in FIG. 24. It is evident from FIG. 24 that AMCOL V has a high degree of shear thinning over a wide range of pH compared to the other two clays, particularly at extremely low and high pHs. All AMCOL purified aluminosilicates AMCOL A, AMCOL B, AMCOL V exhibit similar behavior over a wide range of pH values. The synthetic laponite is only shear thinning at pH values higher than 7 but the laponite formulations do not regain structure as fast as the AMCOL V containing formulations since the latter are more thixotropic in nature. A high degree of shear thinning of rheology modifiers is very desirable when viscous formulations at rest are required to be highly shear thinning and sprayable at high shear.

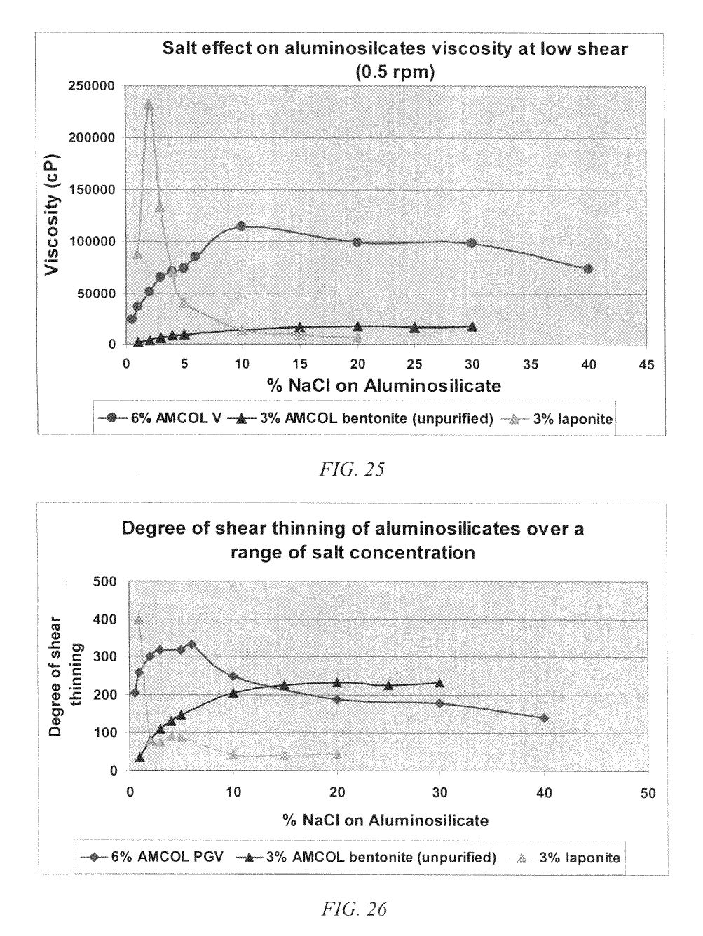

The effects of salt and ionic strength on the same 3 clays are illustrated in FIG. 25. Again, it is apparent from this work that AMCOL V can tolerate a high level of salt and still maintain a high enough viscosity over a much wider range of salt concentration, compared to synthetic laponite and the unpurified bentonite. The laponite can tolerate only up to 5% salt on clay while AMCOL V can maintain consistently high viscosity up to 40% salt on clay. AMCOL purified aluminosilicates AMCOL A, AMCOL B, AMCOL V exhibit similar behavior. The regular bentonites have salts/impurities associated with them and thereby cannot tolerate as high level of salt as the purified and totally salt-free AMCOL V. Although the viscosity of 3% regular bentonite pre-gel is quite low at high salt concentration, its degree of shear thinning is better than the synthetic laponite over the entire range of salt concentration.

### REFERENCES

Iler, R. K. The chemistry of silica, John Wiley and Sons, New York, 1979.
Iler, R. K. The colloid chemistry of silica and silicates, Cornell University Press, Ithaca, N.Y., 1955.

What is claimed is:

1. A sprayable, foaming cleaning composition comprising about 0.5 to about 9% by weight of a layered phyllosilicate, about 0.1 to about 10% of a surfactant, and a pH-adjusting agent selected from the group consisting of silicate salts, strong bases and mixtures thereof, said compositions having a pH of about 10 to about 14, and wherein the composition has resistance to dripping on a vertical substrate.

2. The composition of claim 1, wherein the layered phyllosilicate is selected from the group consisting of smectite clays, montmorillonite clays, bentonite clays, hectorites, ion-exchanged montmorillonite clays, attapulgites, sepiolites, and mixtures thereof.

3. The composition of claim 1, further including about 0.5 to about 10% of a bleaching compound.

4. The composition of claim 1, wherein the pH-adjusting agent is a silicate salt in an amount from about 0.1 to about 10% by weight of the composition.

5. The composition of claim 4, wherein the silicate salt is an alkaline earth or alkali metal salt selected from the group consisting of sodium silicate, potassium silicate, lithium silicate, magnesium silicate, calcium silicate, and mixtures thereof.

6. The composition of claim 1, wherein the pH-adjusting agent is a strong base selected from the group consisting of sodium hydroxide, potassium hydroxide, lithium hydroxide, magnesium hydroxide, calcium hydroxide, and mixtures thereof.

7. The composition of claim 1, further including a hydrotope in a weight ratio of at least 1:1 based on an amount of anionic surfactant in the composition, wherein the pH is about 11 to about 14.

8. The composition of claim 1, comprising about 0.5 to about 3% by weight of a montmorillonite clay; about 1 to about 5% by weight of an amine oxide surfactant; about 0.5 to about 5% by weight of a silicate salt; about 5 to about 20% by weight of a hydrotope; and about 5 to about 25% of one or more ethers.

9. The composition of claim 1, comprising about 0.5 to about 3% by weight of a montmorillonite clay; about 1 to about 5% by weight of an amine oxide surfactant; about 0.25 to about 5% by weight sodium hydroxide; about 0.25 to about 5% by weight water; about 5 to about 20% by weight of a hydrotope; and about 5 to about 25% by weight of one or more ethers.

10. The composition of claim 1, comprising about 0.5 to about 3% by weight of a montmorillonite clay; about 1 to about 5% by weight of an amine oxide surfactant; about 0.5 to about 5% by weight of a silicate salt; about 0.5 to about 10% by weight of a 50% solution of sodium hydroxide in water; about 5 to about 20% by weight of a hydrotope; and about 5 to about 25% by weight of one or more ethers.

11. The composition in claim 1, further including mixed metal oxides/hydroxides to increase a viscosity of the composition and provide shear thinning of the composition in pre-gel form.

12. The composition in claim 1, wherein the phyllosilicate pre-gels contain an extending polymer, such as a polyacrylate in the molecular weight range of 1-15 million Daltons, preferably in the range 1-10 million Daltons, with 100% to 70% anionic character, to provide a further increase in viscosity.

13. The composition in claim 1, wherein the phyllosilicate pre-gels contain non-extending polymers selected from the group consisting of xanthan gum, cellulosics, guar gum, locust bean gum and combinations thereof to provide an increase in viscosity.

14. The composition in claim 1, wherein the phyllosilicate pre-gels contain an optical brighteners such as TiO₂ in an amount of 0.5-15% (w/w) based on the weight of clay and said brightener having a particle size of 0.2-0.3 micron to provide a white formulation and a whiter foam.

15. The composition in claim 1, wherein the pre-gel formulations are sufficiently viscous and have a sufficiently high pH for suspension of negatively charged pigments, optical brighteners, and other aesthetic pigments such as colored pigments, or dye-clay complexes, or food coloring, or pearlescent mica.

16. The composition in claim 1, wherein the pre-gel formulations are prepared with phyllosilicate particles having a size of about 1 micron to about 2 microns such that the pre-gel compositions are beige to brownish or greenish colored and yet provide white to off-white foams due to the size of the phyllosilicate particles generated during the efficient dispersion of the phyllosilicate in the pre-gel state.

17. The composition in claim 1, wherein the high shear viscosity of the phyllosilicate pre-gel compositions is in the range 100-800 cP, more preferably in the range 140-500 cP, and most preferably in the range 150-350 cP, measured at 0.5 rpm with spindle 3 or 4 in a Brookfield Rheometer.

18. The composition in claim 1, wherein the low shear viscosity of the formulation with the phyllosilicate pre-gel compositions is in the range of 3500-100,000 cP, more preferably in the range 10,000-60,000 cP, and most preferably in the range 15,000-45,000 cP, measured at 0.5 rpm with spindle 3 or 4 in a Brookfield Rheometer.

19. The composition of claim 1, wherein the degree of shear thinning of the formulations as defined by the ratio of viscosity at 0.5 rpm to the viscosity at 200 rpm is in the range of 10-400, more preferably in the range of 40-350, most preferably in the range of 140-350.

20. The composition of claim 1, wherein the phyllosiliate pre-gels are highly thixotropic and highly shear thinning at high shear, but regain sufficient viscosity at low shear such that the foam from the composition is non-dripping on a vertical surface.

21. The composition of claim 1, wherein all particles are above 100 nm in particle size and, therefore, are not nano particles.

22. The composition of claim 1, comprising less than about 2% by weight of volatile organic compounds.

23. The composition of claim 22, comprising less than about 0.5% by weight of volatile organic compounds.

24. The composition in claim 2, wherein the phyllosilicates has a cation exchange capacity (CEC), in the range of 25-160 meq/100 gm clay, and are in a form selected from 100% sodium exchangeable cations, and mixed exchangeable cations selected from the group consisting of sodium, calcium, and magnesium.

25. The composition of claim 1, wherein the pH-adjusting agent is a combination of a silicate salt and a strong base, and wherein the composition has a pH of about 10 to about 11.5.

26. The composition of claim 1, wherein the pH-adjusting agent is a strong base, and wherein the composition has a pH of about 11 to about 13.5.

27. The composition of claim 26, wherein the composition has sufficient strong base to raise the pH of the composition in the range of 12.5 to 13.5.

28. The composition of claim 7, wherein the hydrotype is selected from the group consisting of sodium xylene sulfonates, sodium cumene sulfonates, sodium toluene sulfonates, ethanol, isopropanol, propylene glycol, polyethylene glycol ethers, alkyl polyglucosides.

29. The composition of claim 3, wherein the bleaching agent is selected from the group consisting of sodium hypochlorite (NaOCl); hydrogen peroxide; sodium perbonate; sodium percarbonate; tetra acetyl ethylene diamine; and mixtures thereof.

30. A method of providing sprayability and foam in a composition having a pH in the range of 10 to 14 that contains about 0.5 to about 6% by weight of a layered silicate and an anionic surfactant, comprising adding a hydrotope to said composition in an amount of at least a weight ratio of 1:1 based on the weight of anionic surfactants in the composition.

31. The method of claim 30, wherein the hydrotype is selected from the group consisting of sodium xylene sulfonates, sodium cumene sulfonates, sodium toluene sulfonates, ethanol, isopropanol, propylene glycol, polyethylene glycol ethers, alkyl polyglucosides.

32. A sprayable, foaming cleaning composition comprising about 0.5 to about 9% by weight of a layered phyllosilicate, about 0.1 to about 10% of a surfactant, and a pH-adjusting agent, wherein the composition is in the form of a oil-in-water macro-emulsion or an oil/water microemulsion having an oil phase and an aqueous phase, said oil phase comprising a water-insoluble oil or solvent selected from the group consisting of degreasing oils or solvents, disinfecting oils or solvents, and fragrance-releasing oils or solvents.
